(19) United States
(12) Patent Application Publication
(10) Pub. No.: US 2015/0070190 A1
(43) Pub. Date: Mar. 12, 2015

(54) Sensor Apparatus and Related Methods

(71) Applicant: Quirky, Inc., New York, NY (US)

(72) Inventors: Denny Choun WAI FONG, Toronto (CA); Gabor PAULKE, New York, NY (US); Dan TURK, New York, NY (US); Sam ANDERSON, New York, NY (US); Devyn BYRNES, New York, NY (US); Faris ELMASU, New York, NY (US); Nicholas OXLEY, New York, NY (US)

(21) Appl. No.: 14/484,851

(22) Filed: Sep. 12, 2014

Related U.S. Application Data
(60) Provisional application No. 61/877,213, filed on Sep. 12, 2013.

(51) Int. Cl. H04W 84/18; G01N 19/10; G01P 15/08

(52) U.S. Cl. CPC H04W 84/18; G01P 15/08; G01N 19/10
USPC 340/870.3; 29/592.1

(57) ABSTRACT

An exemplary aspect comprises an apparatus comprising: (a) a microprocessor; (b) a wireless transmitter/receiver in communication with the microprocessor and operable to communicate over a wireless network with an application on a mobile device; (c) a light sensor in communication, via the microprocessor and the transmitter/receiver, with the application, and operable to detect and report ambient light levels in a vicinity of the apparatus; and (d) an accelerometer in communication, via the microprocessor and the transmitter/receiver, with the application, and operable to detect and report motion of the apparatus. In various exemplary embodiments, the apparatus may further comprise (and/or instead comprise): (1) a temperature sensor; (2) a humidity sensor; (3) a microphone; and/or (4) a passive infrared sensor.

### CROSS-REFERENCE TO RELATED APPLICATIONS

This application claims priority under 35 U.S.C. 119(e) to U.S. Provisional Patent Application No. 61/877,213, filed Sep. 12, 2013, and entitled “Sensor Apparatus and Related Methods.” The entire contents of the above-referenced application are incorporated herein by reference.

### INTRODUCTION

An exemplary embodiment comprises a sensor apparatus having a plurality of environmental sensors and operable to communicate wirelessly with a mobile device.

Such sensors may be deployed, for example, throughout (and/or outside) a home to monitor a variety of conditions including, for example: temperature, humidity, light, sound, and/or vibration (motion). Motion may be detected via an accelerometer to detect whether an attachment surface is moving and/or via passive infrared to detect movement within a certain beam.

An exemplary aspect comprises an apparatus comprising: (a) a microprocessor; (b) a wireless transmitter/receiver in communication with the microprocessor and operable to communicate over a wireless network with an application on a mobile device; (c) a light sensor in communication, via the microprocessor and the transmitter/receiver, with the application, and operable to detect and report ambient light levels in a vicinity of the apparatus; and/or (d) an accelerometer in communication, via the microprocessor and the transmitter/receiver, with the application, and operable to detect and report motion of the apparatus.

In various exemplary embodiments, the apparatus may further comprise (and/or instead comprise): (1) a temperature sensor in communication, via the microprocessor and the transmitter/receiver, with the application, and operable to measure and report temperature in a vicinity of the apparatus; (2) a humidity sensor in communication, via the microprocessor and the transmitter/receiver, with the application, and operable to measure and report relative humidity in a vicinity of the apparatus; (3) a microphone in communication, via the microprocessor and the transmitter/receiver, with the application, and operable to detect and report sound in a vicinity of the apparatus; and/or (4) a passive infrared sensor in communication, via the microprocessor and the transmitter/receiver, with the application, and operable to detect and report motion in a vicinity of the apparatus.

In various exemplary embodiments: (1) the apparatus is battery powered; (2) the apparatus is further operable to communicate wirelessly with other home network devices via the wireless network; (3) the microprocessor is mounted on a circuit board that enables interchangeability of at least the light sensor and another sensor; and/or (4) the application enables a user to selectively activate and deactivate at least the one sensor on the apparatus.

Other exemplary aspects comprise methods of modifying an interchangeable (i.e., modular) embodiment of the apparatus, comprising: (a) removing a first sensor from the apparatus, and replacing the first sensor with a second sensor; (b) removing a sensor from the apparatus; and/or (c) adding a sensor to the apparatus.

Another exemplary aspect comprises a non-transitory computer readable medium storing software that enables a user to select one or more sensors to be included in a modular embodiment of the apparatus.

Further aspects, details, and embodiments will be apparent from the drawings and the description below.

### BRIEF DESCRIPTION OF THE DRAWINGS

FIG. 1 depicts an exemplary sensor apparatus embodiment.

FIG. 2 illustrates several exemplary components and corresponding materials and construction.

FIG. 3 depicts exemplary dimensions of an embodiment.

FIG. 4 depicts exemplary usage scenarios.

FIGS. 5-9 depict exemplary components and construction.

FIGS. 10-13 depict exemplary circuitry.

FIGS. 14-43 depict exemplary features and functionality of an app of an embodiment.

FIGS. 44-46 and 53 depict exemplary features of an embodiment.

FIG. 47 depicts an exemplary modular circuit board, in a four-sensor configuration.

FIG. 48 depicts an exemplary modular circuit board, without an accelerometer.

FIGS. 49-50 and 52 depict how different sensor plates may correspond to different sensors.

FIG. 51 depicts an exemplary user interface for selecting sensors and options.

FIG. 54 depicts various exemplary configurations and color schemes.

FIG. 55 depicts an exploded view of an exemplary modular embodiment.

### DESCRIPTION OF SELECT EXEMPLARY EMBODIMENTS

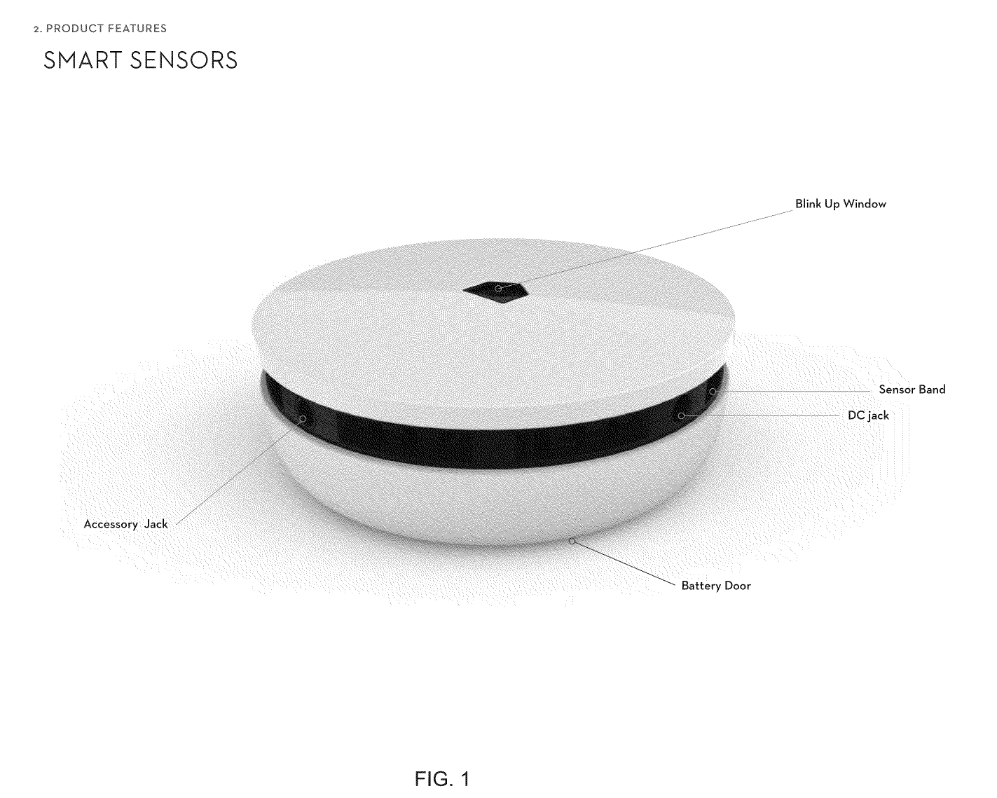

As noted above, an exemplary embodiment comprises a sensor apparatus. See FIG. 1.

In an exemplary embodiment, the sensor may transmit data to the user in preselected conditions/intervals, and/or on demand via WiFi. In an exemplary embodiment, the sensor apparatus may comprise a WiFi communication device such as available from Electric Imp (see the description in U.S. Provisional Pat. App. No. 61/877,213) or Broadcom. The WiFi communication device (referred to herein as “WiFi module”) may communicate with an application (“app”) on a mobile or other computing device (referred to herein for convenience as a “smart phone”).

In an exemplary embodiment, the sensor apparatus, in conjunction with the WiFi module and the app, reports sensor information to a user. Data may be transmitted via the WiFi module to the app (via, for example, a router and a server) for user status access and notification updates.

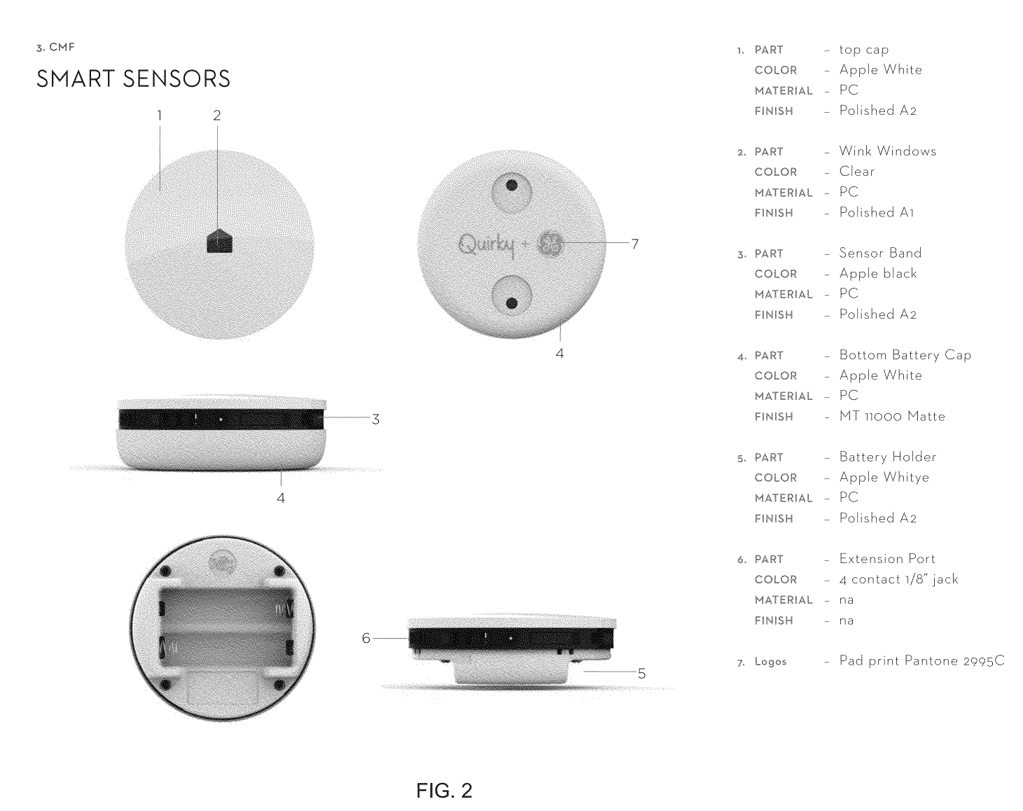

Exemplary materials (see FIG. 2) comprise PC, ABS, PMMA, and/or combinations thereof (e.g., a PC/ABS blend). Those skilled in the art will understand that these are intended to be exemplary materials only, and that the listed components may be made of other materials without departing from the scope of the invention.

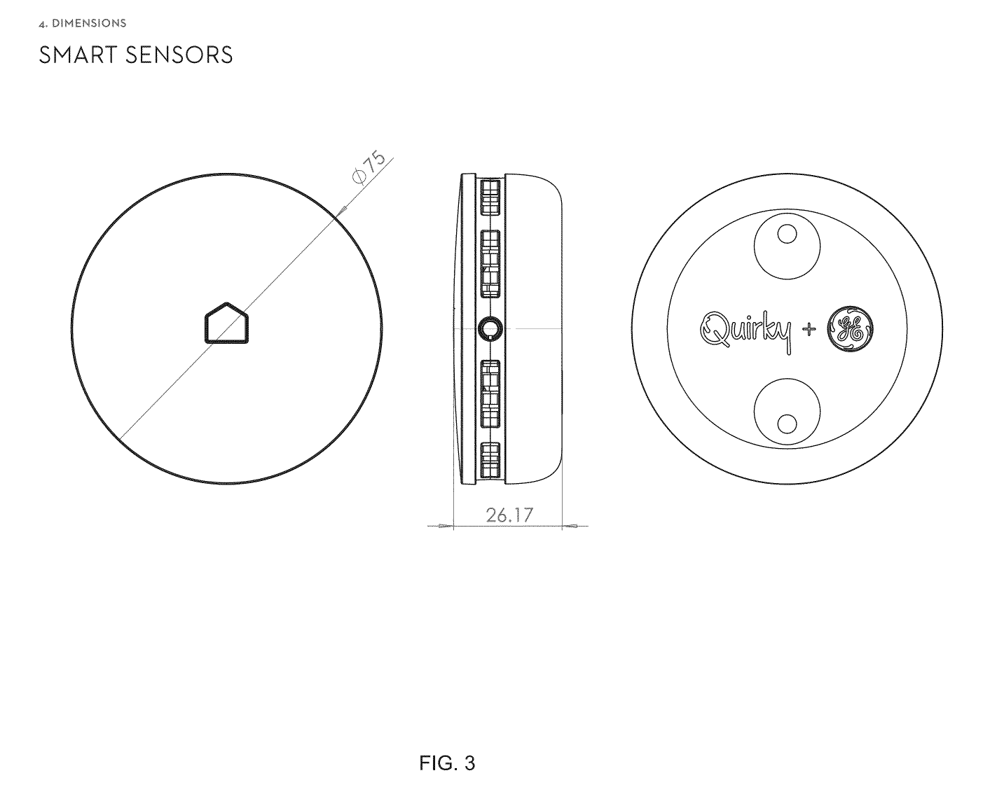

Exemplary dimensions (see FIG. 3) are, for example, 75 mm×75 mm×26 mm. Those skilled in the art will understand that these are intended to be exemplary dimensions only, and that the apparatus may have, and will have, other dimensions without departing from the scope of the invention.

Exemplary Features:
Sensor may operate within a specified temperature range (for example, from −20° F. to 140° F., from −20° C. to 50° C., or from −20° C. to 50° C.);
Components may operate out of the spec range of some AA cells;
Sensor may be “weather-proof” enough to be located outside, yet not sealed so well as to prevent air flow to the sensors;
Sensor may resist solar heating;
Sensor may be easy to install on several orientations and/or surfaces (using, e.g., adhesive backing, suction cup backing, magnetic, screw attachment, etc.);
May be powered by 2 AA batteries and last 1+ yrs. with normal operating functions.

Exemplary Sensors/Features:
Temperature
Humidity
Microphone Sound Sensor
Light Intensity Sensor
3 Axis Accelerometer
Switch (electrical or mechanical) for power on/off or start sensing
Passive Infrared Sensor

Referring to FIG. 1, an exemplary housing may comprise an accessory jack, a battery door, a DC jack, a sensor band, and/or a blink up window.

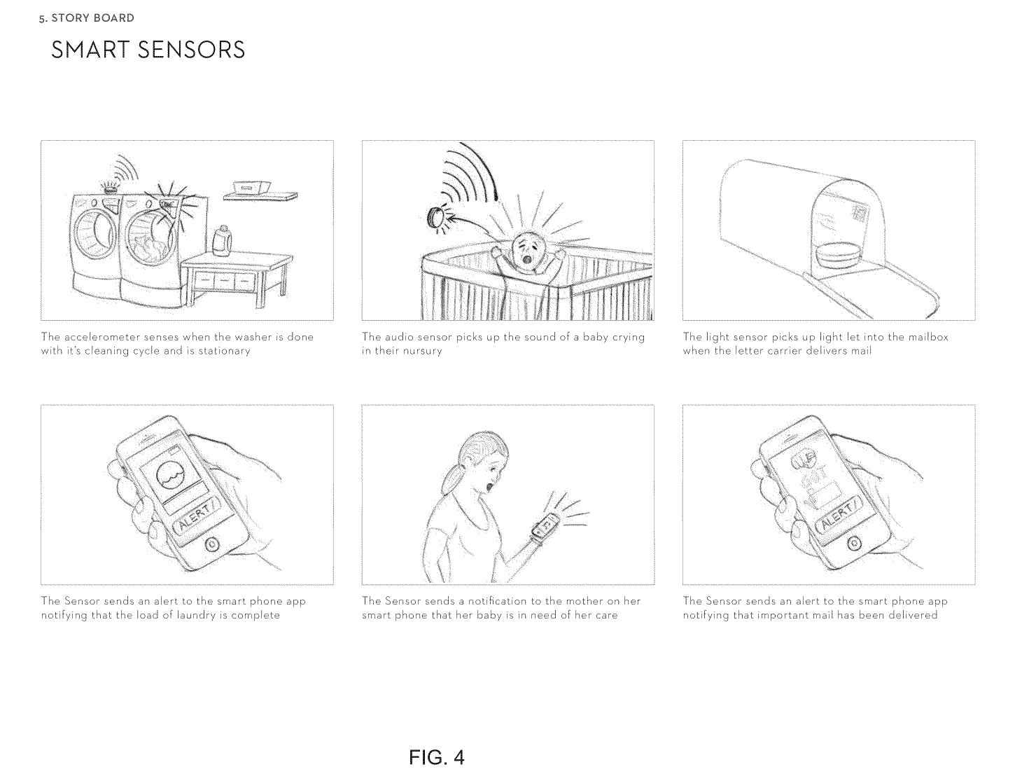

As depicted in FIG. 4, an accelerometer may sense when a washer has finished a cycle (because movement has stopped). The Sensor apparatus then sends an alert to a user's smart phone app notifying that the cycle has finished.

An audio sensor may pick up the sound of a baby crying. The Sensor apparatus then sends a notification of the baby crying to the mother's smart phone.

A light sensor mounted in a mailbox can alert a user when the mailbox is opened—i.e., when a letter carrier delivers mail. The Sensor apparatus then sends an alert to a user's smart phone app notifying that the mail has been delivered.

A passive infrared sensor mounted facing a feeding bowl may pick up the presence of a pet approaching. The sensor apparatus then sends an alert to the user's smart phone app notifying that the pet has eaten.

Other uses of the Sensor apparatus will be apparent to those skilled in the art. For example, light, sound, and/or the accelerometer may be used to indicate when a door or window has been opened, thus providing a homeowner with additional security. Temperature and/or humidity sensors can alert the user to potential heat and/or water problems.

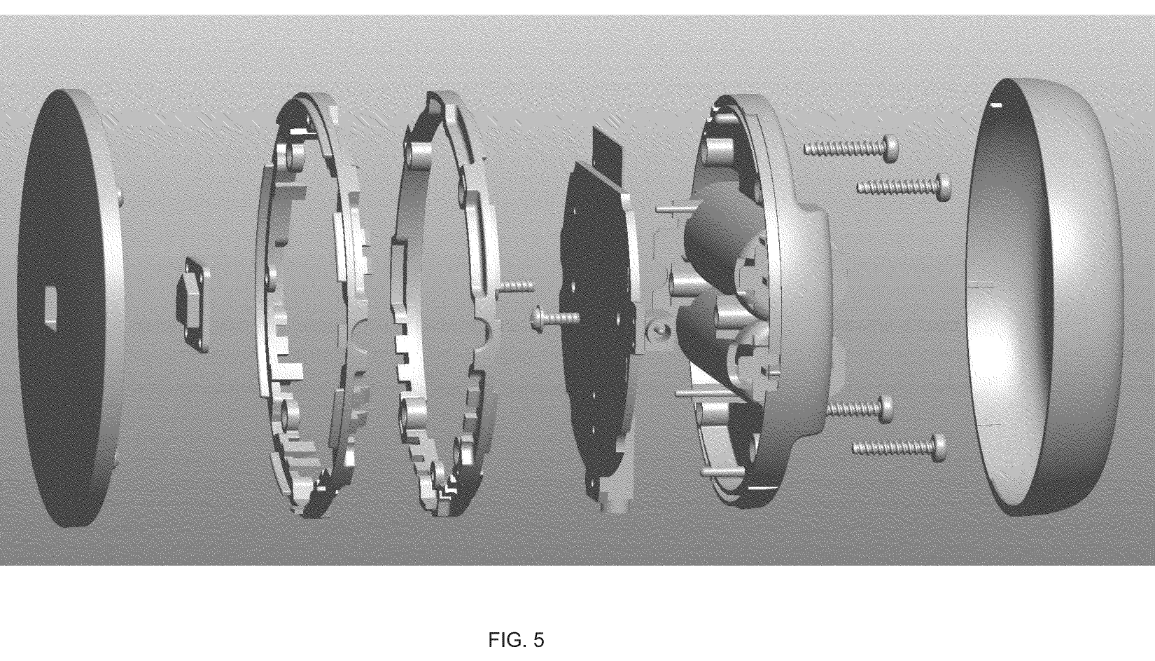

In one exemplary configuration, housing components comprise Top, Sensor Ring Top & Bottom halves, Battery Holder, and Base. Any or all may be made of molded thermoplastics such as Polycarbonate (PC), Polyamide, ABS, and/or combinations thereof. See FIGS. 5-9.

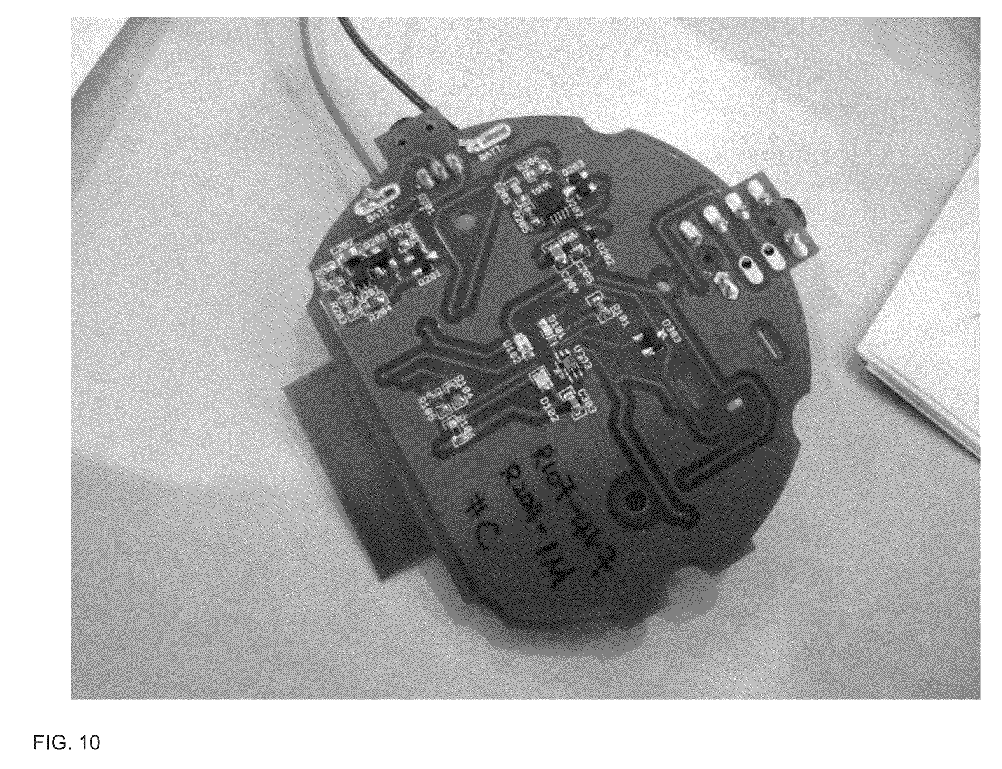

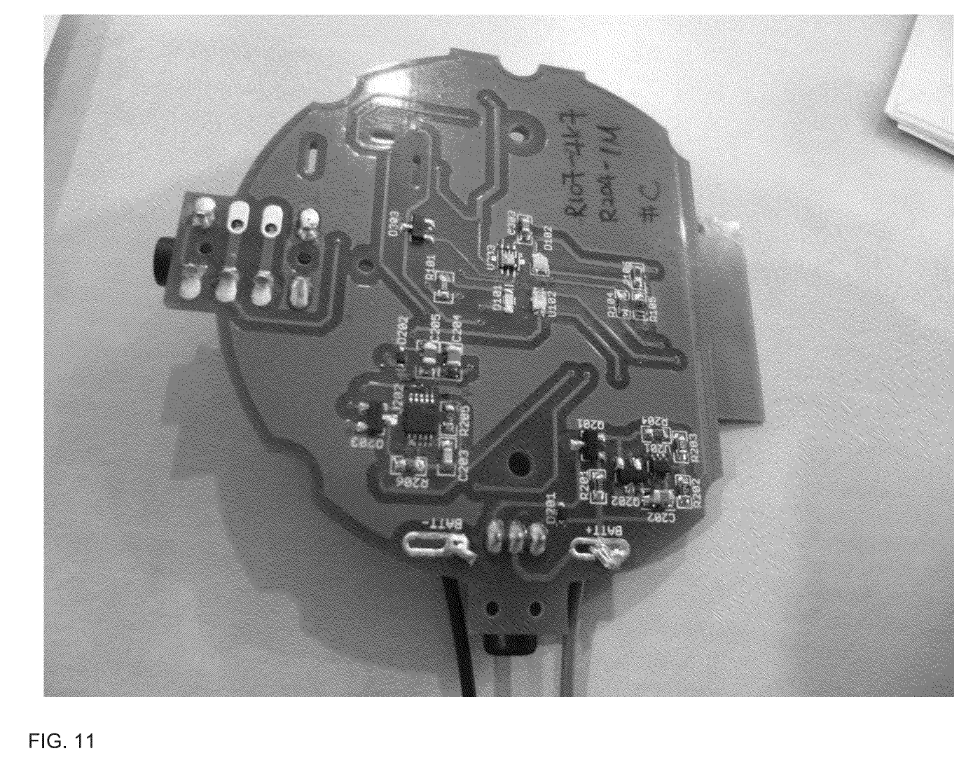

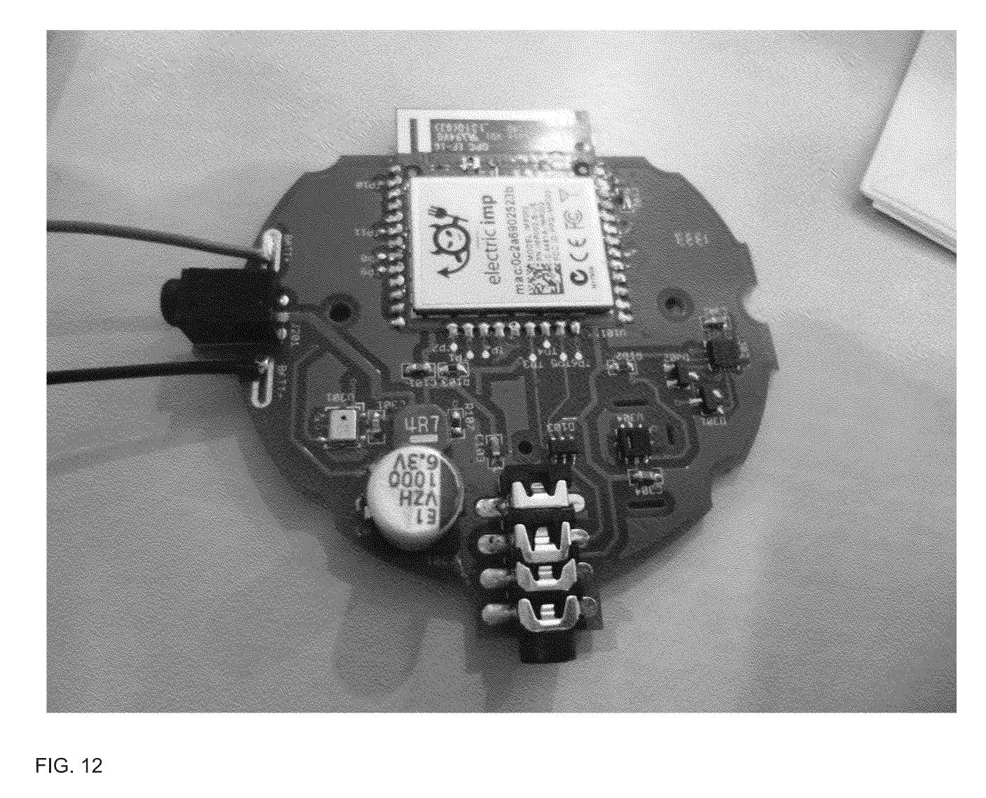

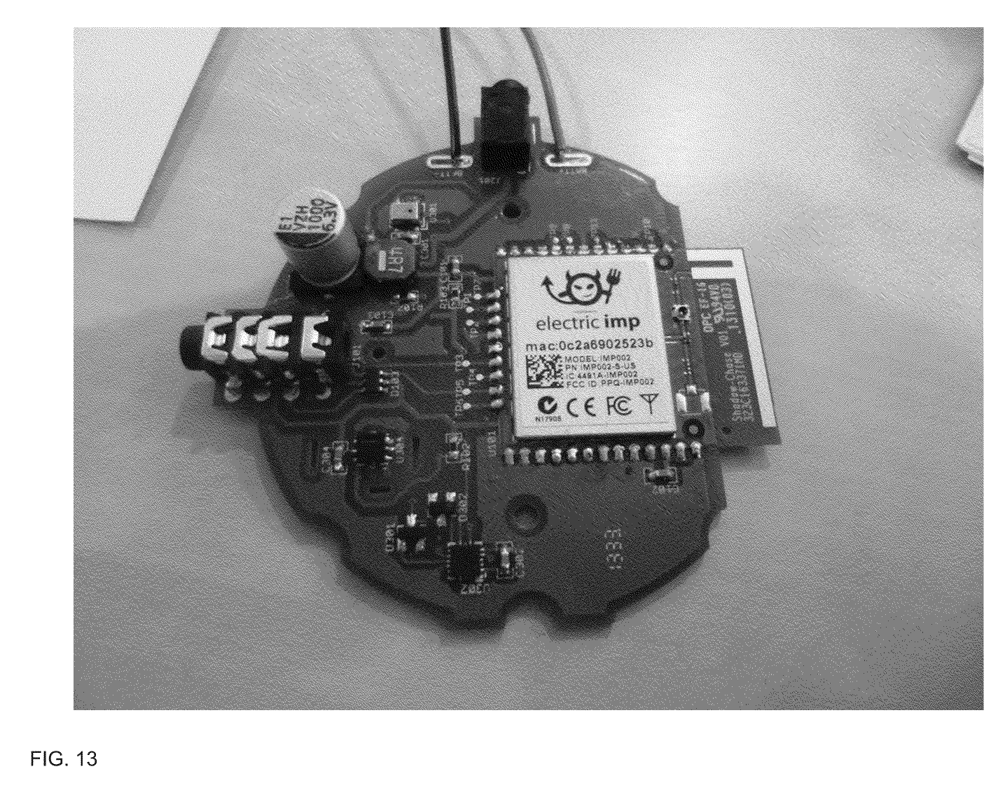

The housing may contain a printed circuit board (PCB) (see FIGS. 10-13) onto which may be mounted the sensors, WiFi Module chip, battery terminals, external jack, and DC jack.

The PCB may be located between the Top and Battery Holder, and may be surrounded by a Sensor Ring.

The PCB may be mounted on the Battery Holder via screws.

Microphone, temperature, and humidity sensors, if included, may be positioned near a slotted opening on a Sensor Ring to be more exposed to outside temperature, sound, etc.

The light sensor may be located, for example, in the center of the PCB directly under a transparent “window” component (mounted to the Top) so that it can detect light.

The unit may be assembled via snap fits, or via 4 screws which fasten the Battery Holder to the Top, capturing the Sensor Ring in between. The Base then may slide onto the Battery holder and twisted 45 degrees to lock it into place. To unlock (e.g., when opening the unit to change the batteries), a user turns the base counterclockwise and slides it off.

The base may have magnets, holes, and debosses which can hold pieces of foam tape, and/or a debossed ring, for mounting the unit. If a user wishes to mount the Sensor device on a refrigerator, dryer or anything metal, the magnets may be used. For mounting to wood, drywall, etc., screws through the holes in the base may be used. For mounting to other surfaces, the foam tape may be used. The Sensor apparatus may thus be mounted to several types of different surfaces.

An external adapter may be plugged into the DC jack if the user doesn't want to use batteries.

An external jack can be used for an external thermometer, microphone, and other inputs.

The Battery Holder may hold two AA (or other types of) batteries.

The user determines which functions to monitor (e.g., movement, light, sound, temperature, and/or humidity) via selection on the smart phone app. Then when the unit is in use, it will notify the user via the app whenever that function is triggered, or the set level (of degrees, movement, loudness, etc.) is exceeded.

Exemplary Sensors and Other Components:
Microphone—MSM42A3729H4
Accelerometer—LIS3DHTR
Temp/Humidity Sensor—SHT20
Light Sensor—LTR-303ALS-01
DC jack—HDC-202H
External jack—PJ3013B

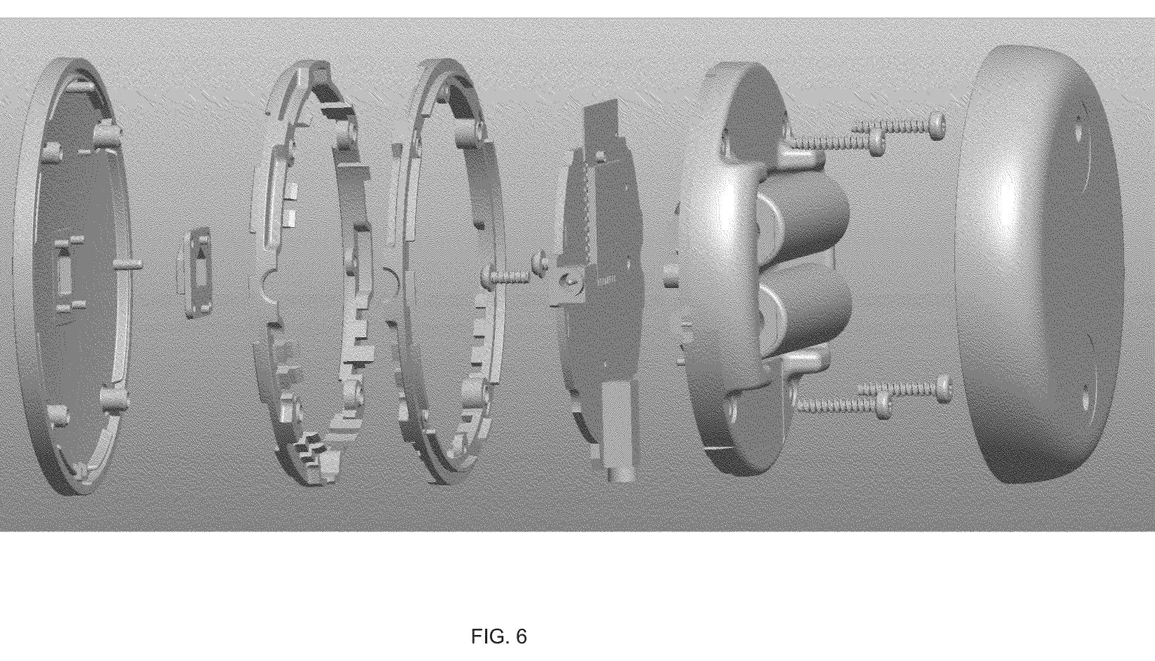

FIGS. 5 and 6 are exploded views which show exemplary housing components from left to right: top, window, sensor ring top and bottom half, PCB, Battery Holder w/batteries, base.

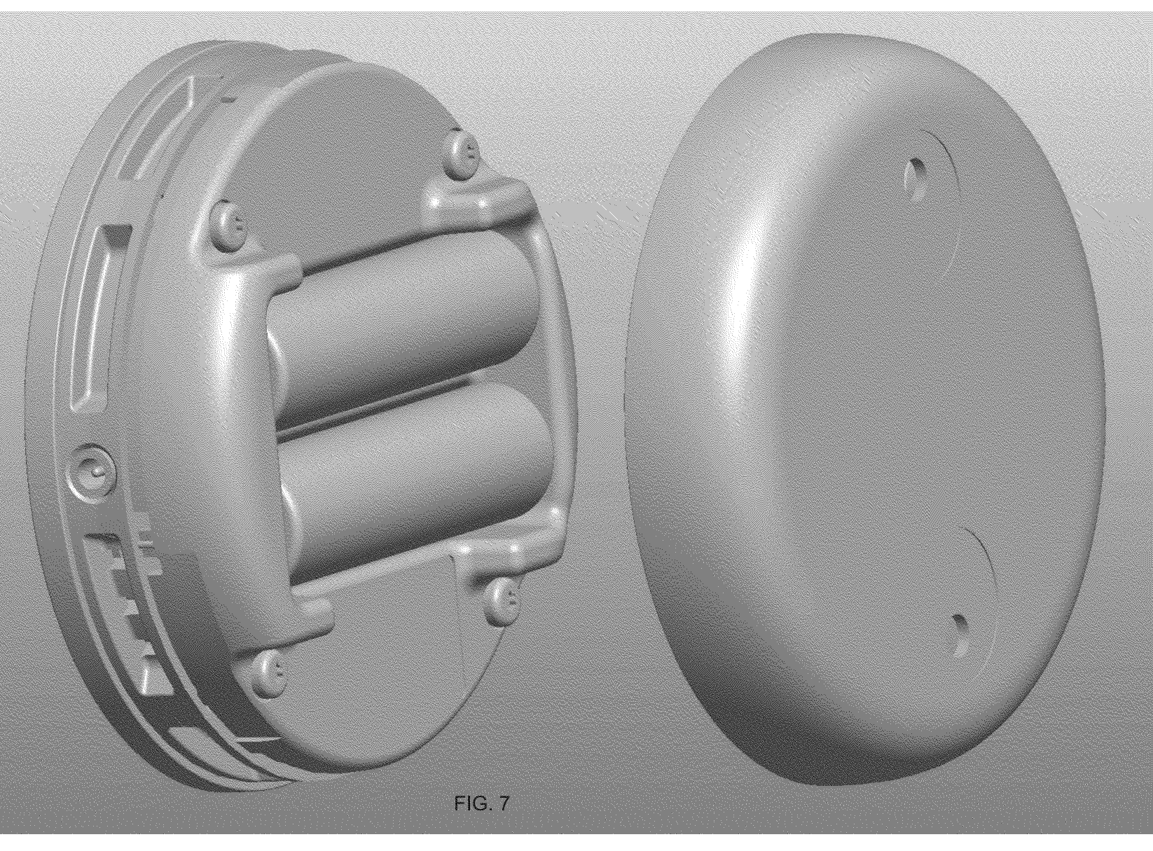

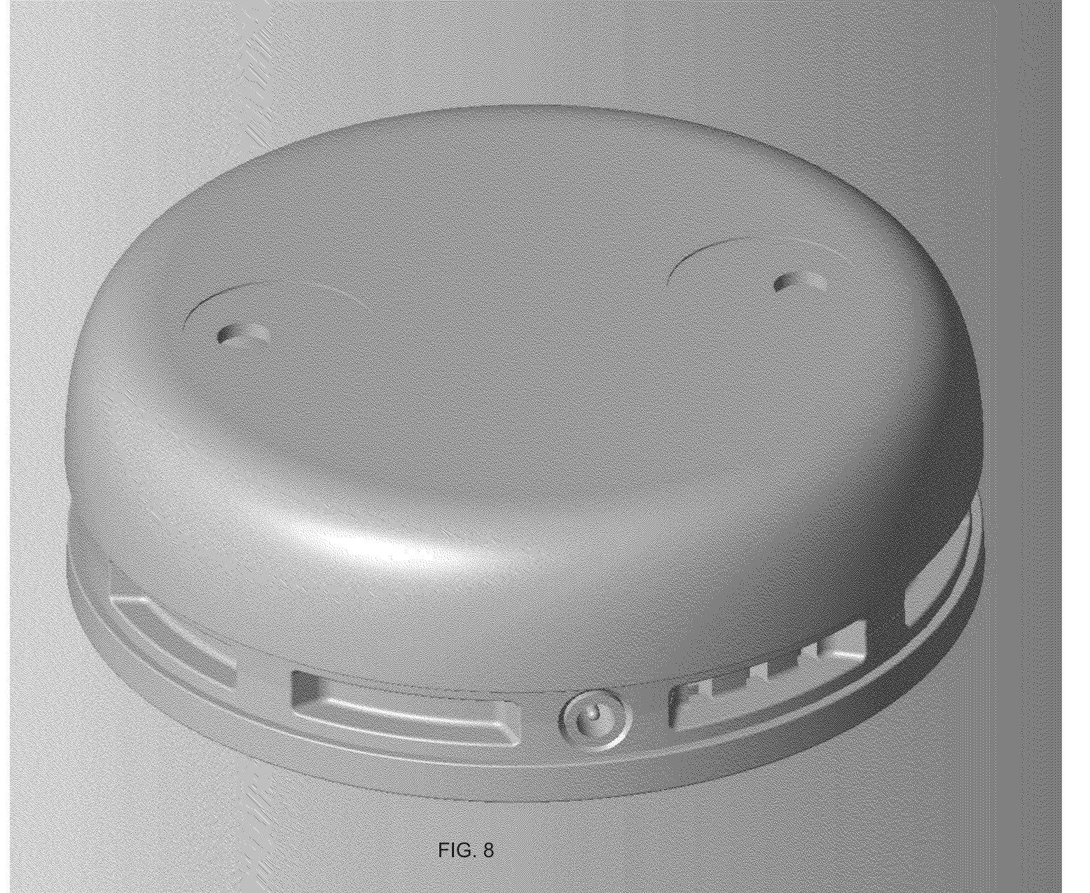

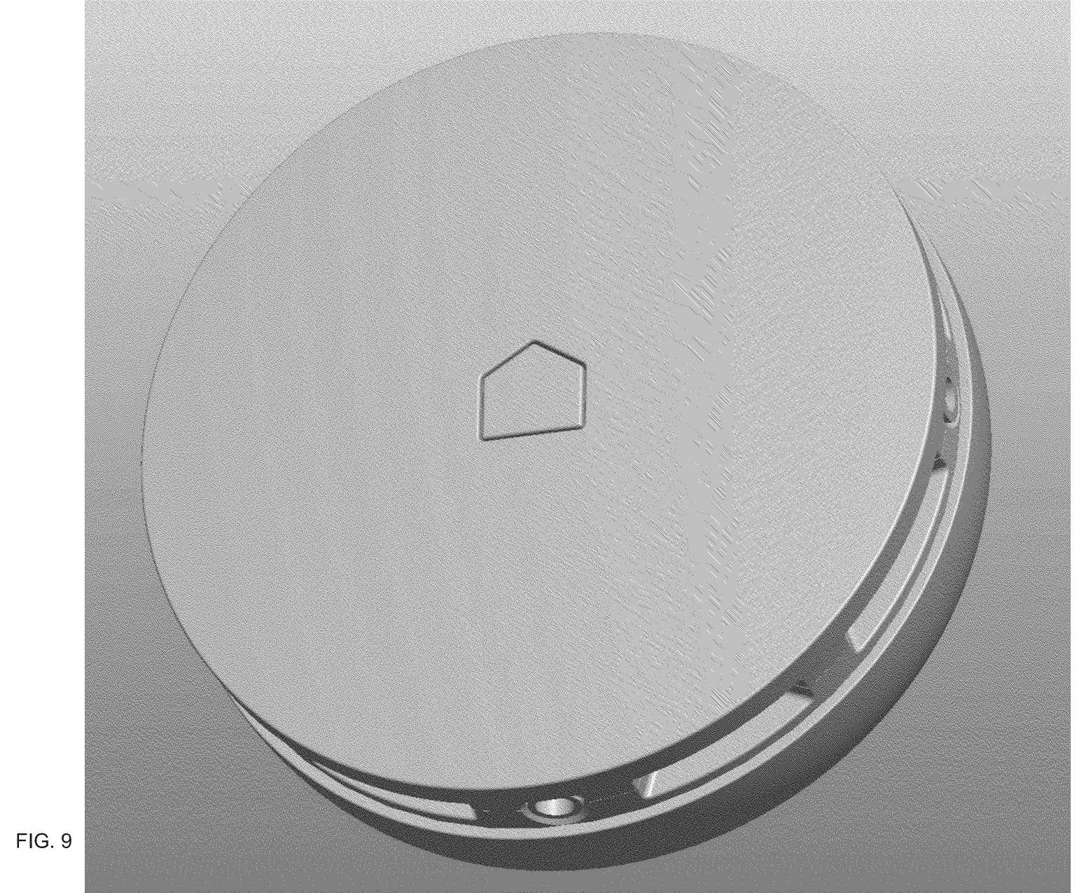

FIG. 7 shows the unit assembled with the base off, and FIGS. 8 and 9 are views of the unit assembled and closed.

FIGS. 10-13 depict an exemplary PCB layout.

Exemplary features and functionality of the app are described below.

After installing and opening the app, the user may view a settings screen (see, for example, the Dashboard view described below). In the settings screen, a user may set a threshold for each sensor for an alert regarding changes in status. The app may have a default threshold for each sensor (e.g., 32° F. for a temperature sensor).

The user also may set the app so that an alert is sent when the user is at a certain location, and/or sent at a certain time. For example, at the user's normal wakeup time, and when at home, the user may wish to receive a report of the external temperature and humidity.

In addition to a settings screen, the app may have a main screen, which may show the status of each sensor.

Other notifications that may be provided include a low battery notification for the Sensor apparatus.

The status of each sensor may be stored locally and in the Cloud. The WiFi module may upload the information whenever a change (e.g., above a certain threshold) is detected by any of the sensors. A user may use the app to set a threshold and update the Sensor apparatus, separately for each sensor.

In certain of the exemplary embodiments described below, the Sensor apparatus is designated “Spotter”.

Spotter Main Screen

When the Spotter is plugged in:

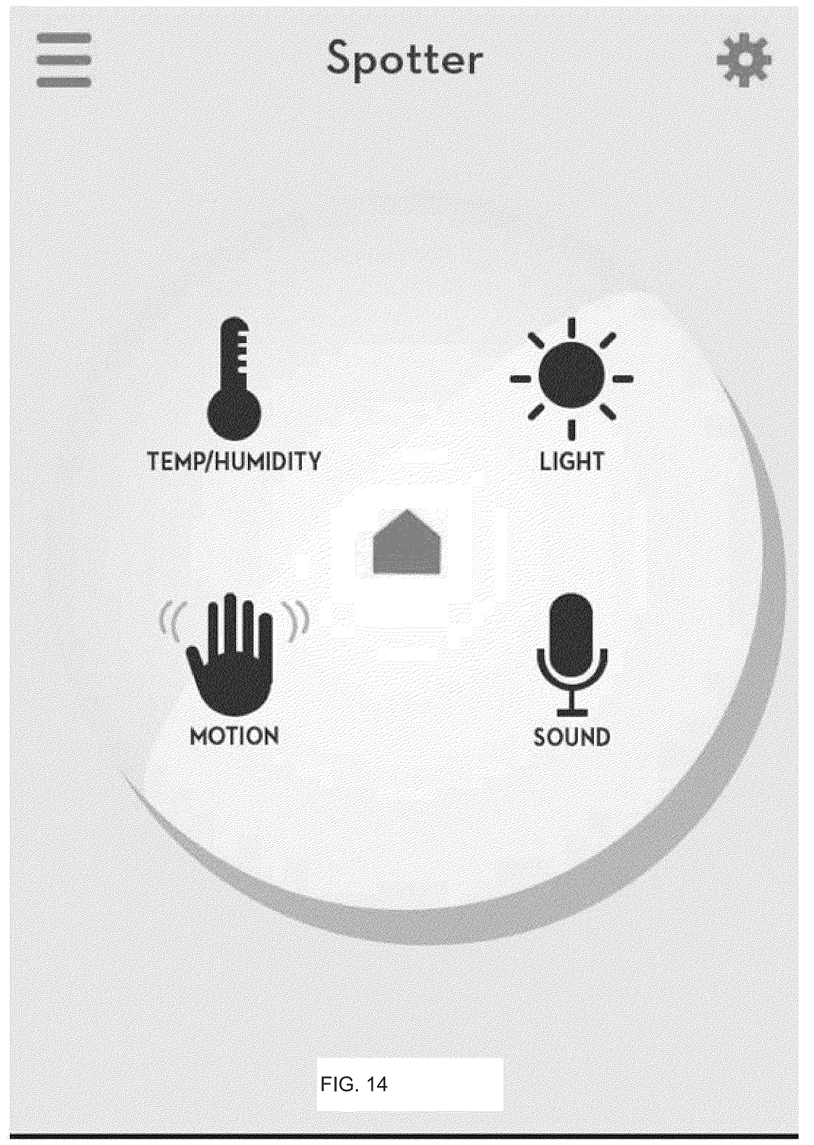

A Dashboard view (see FIG. 14) is presented that shows the current status of the sensors:

Temperature

Humidity

Light levels detected

Motion detected

Sound detected

Clicking on the status of a sensor will take the User to a Sensor Detail View.

Sensor Detail View
Showcases a graph for the particular sensor over a 24 hour period. For example, temperature over the last 24 hours. Shows last update if in battery mode.
A list of recipes for that particular sensor
Button to add a new recipe

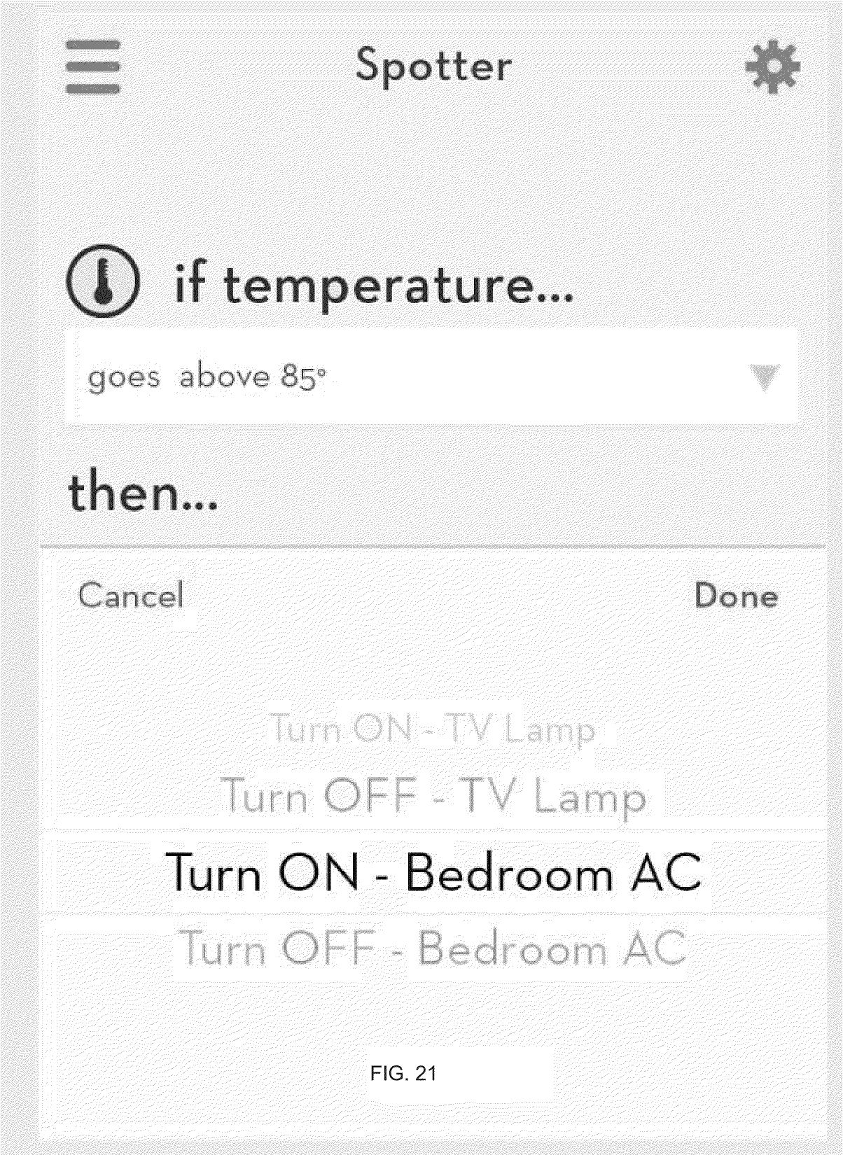

Below the above information a scrolling list of recipes may be displayed (see FIG. 21).

A recipe in the list may:
have an icon representing which sensor it's based on
have a name for the item
have a toggle to turn the recipe on/off
be tappable to edit.

There may be a button to add a new recipe.

When the Spotter is on battery power, the dashboard view may show values from the last time the Spotter sent an update. This may be separate from the current values the Spotter is detecting. A message may prompt the user to tap Spotter twice to transmit the current values to the cloud in order to refresh the information presented on the dashboard.

Recipes View

Recipes are sets of rules that follow the “If this, then that” concept. “If the temperature goes over 90 degrees, then send me a push notification” is a recipe.

“If” Rules:
If Light . . . (see FIG. 29)
   Goes from dark to bright
   Goes from bright to dark
   Changes light levels
If motion
   Goes from static to moving
   Goes from moving to static
   Changes movement
If sound
   Goes above a certain decibel level
   Goes below a certain decibel level
   Changes by X decibels
   A certain sound pattern is detected (two slow claps or three quick claps)
If temperature
   Goes above a certain temperature
   Goes below a certain temperature
   Changes by X degrees
If humidity
   Goes above a certain level
   Goes below a certain level
   Changes by X percent humidity

Then
Send a push notification
Send an email
Send a tweet (auth)
Connect with IFTTT

As is known, IFTTT enables users to create and share “recipes” that fit the simple statement: “if this, then that”. The “this” part of a recipe is a trigger. The “that” part of a recipe is an action. Some example actions are “send me a text message”; “send a push notification; and “send me an email.”

Wink Robots may be used to trigger actions in other Wink-enabled devices.

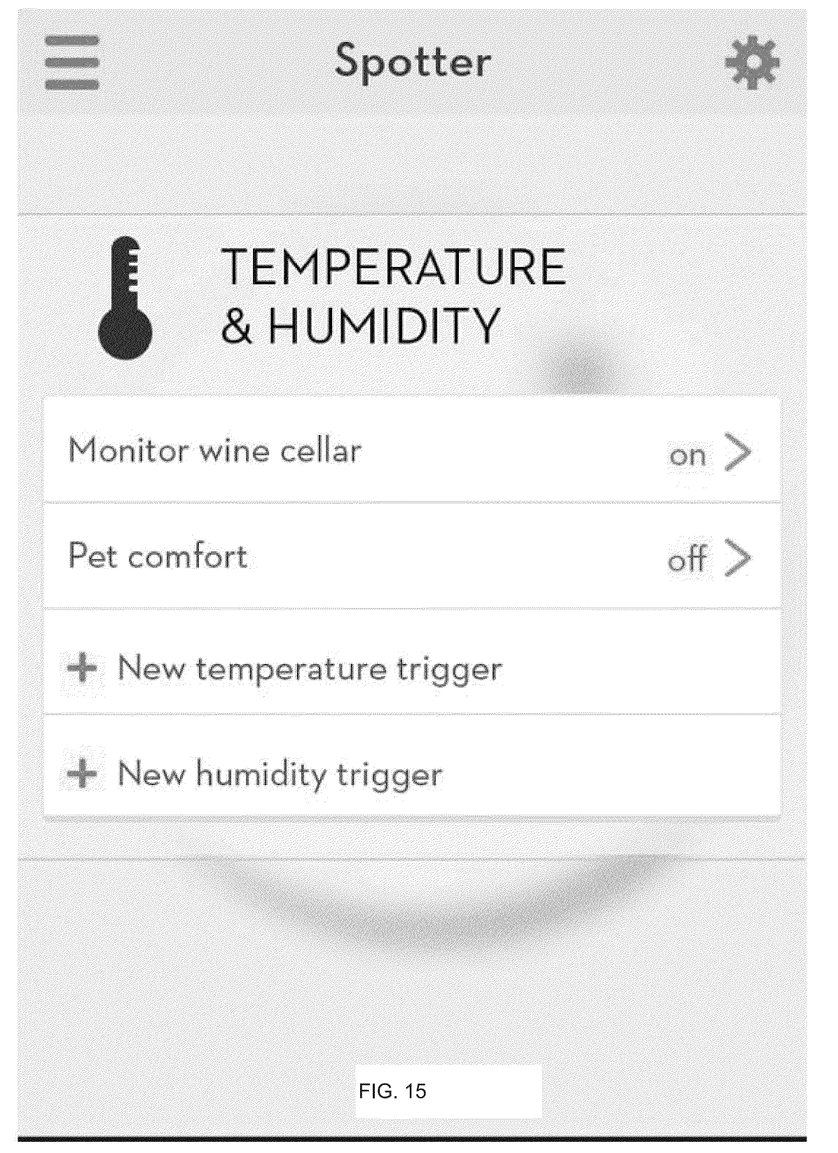

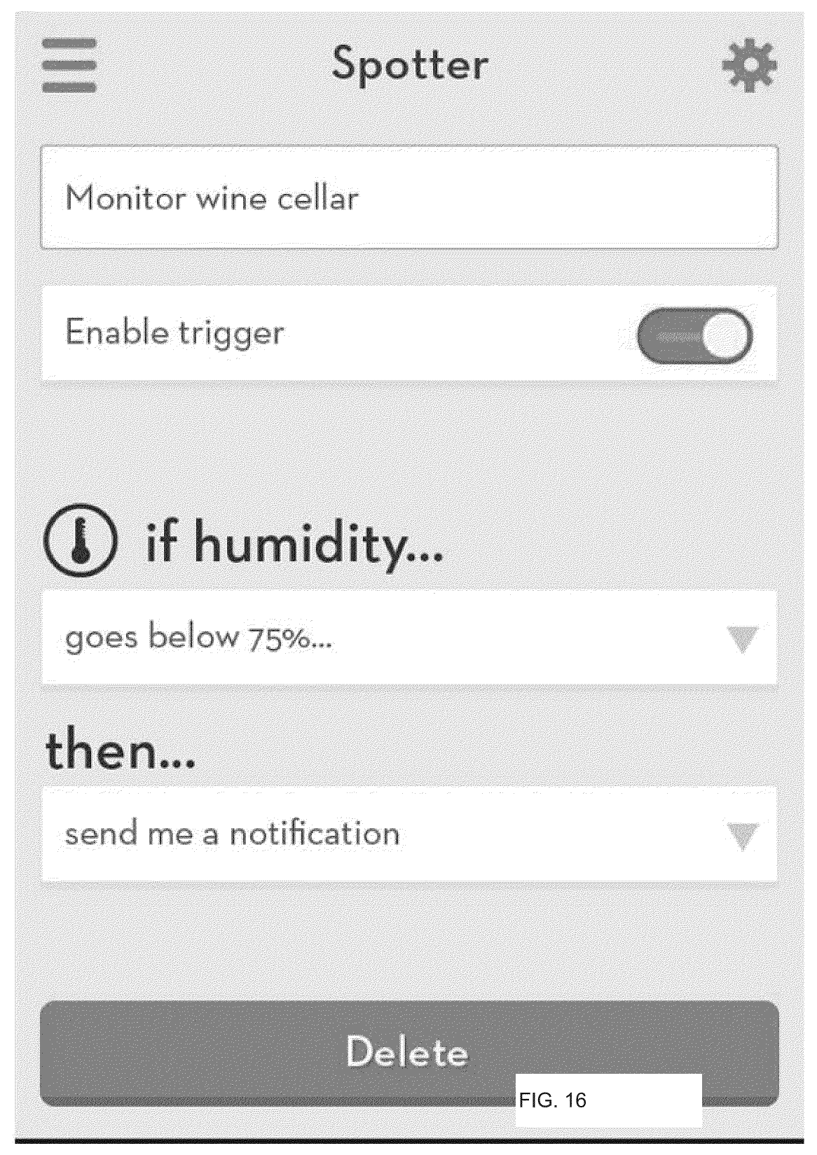

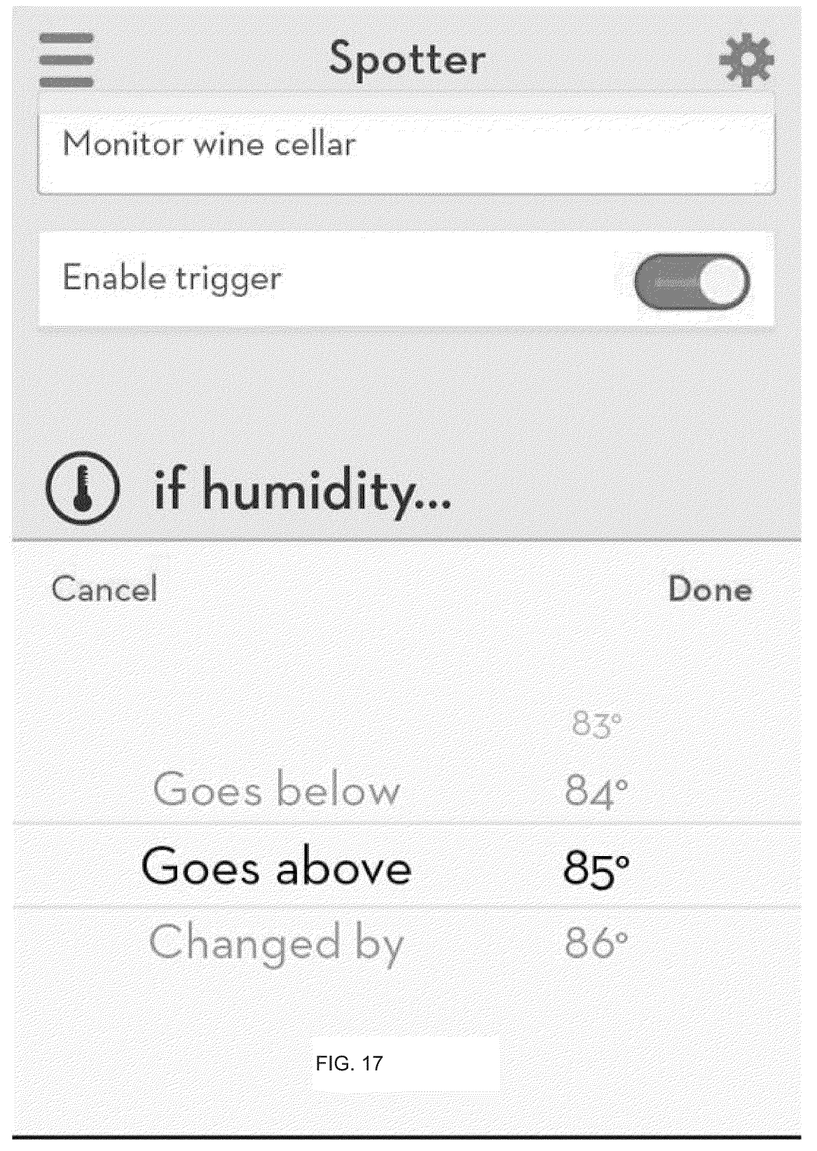

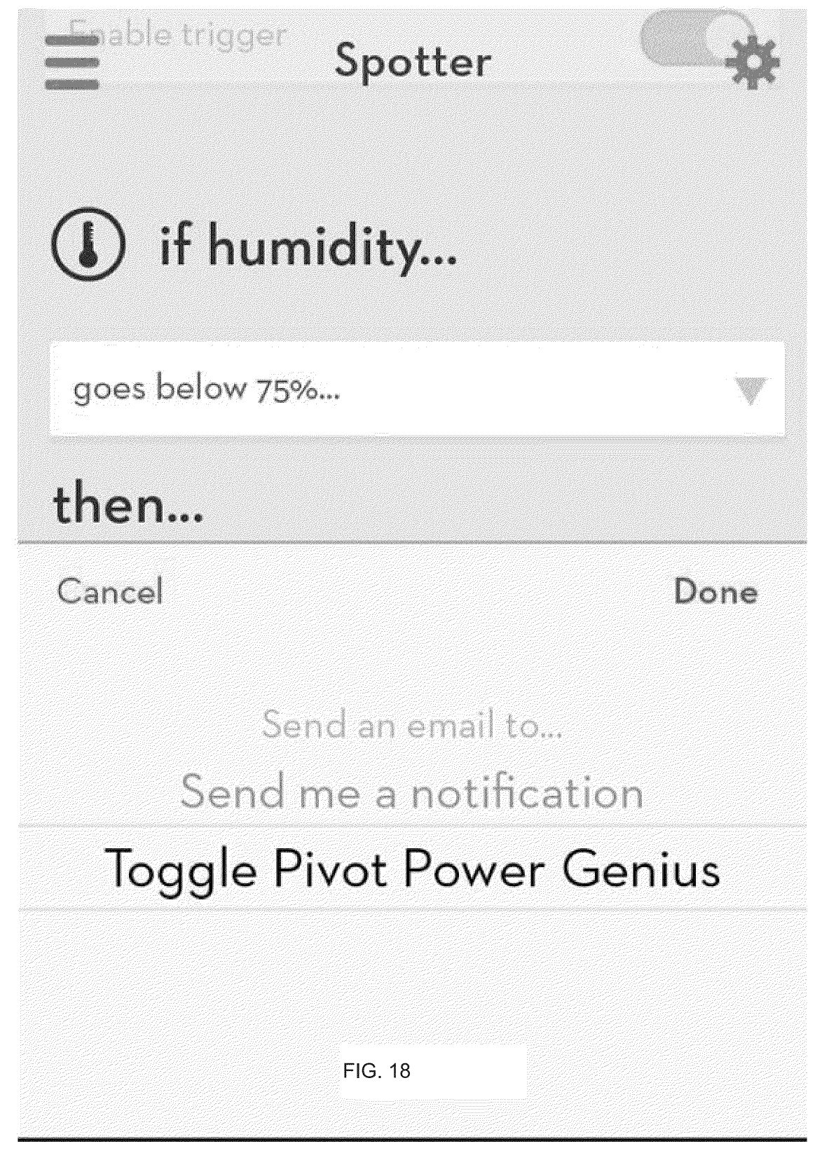

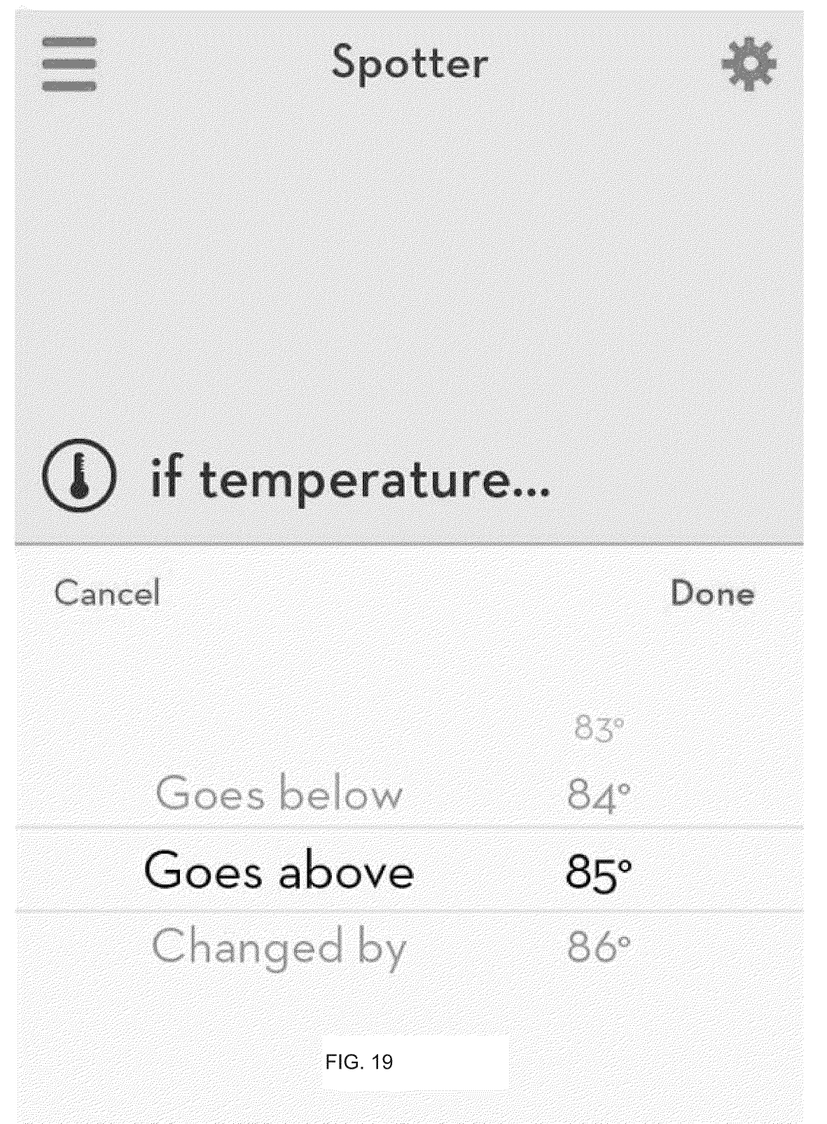

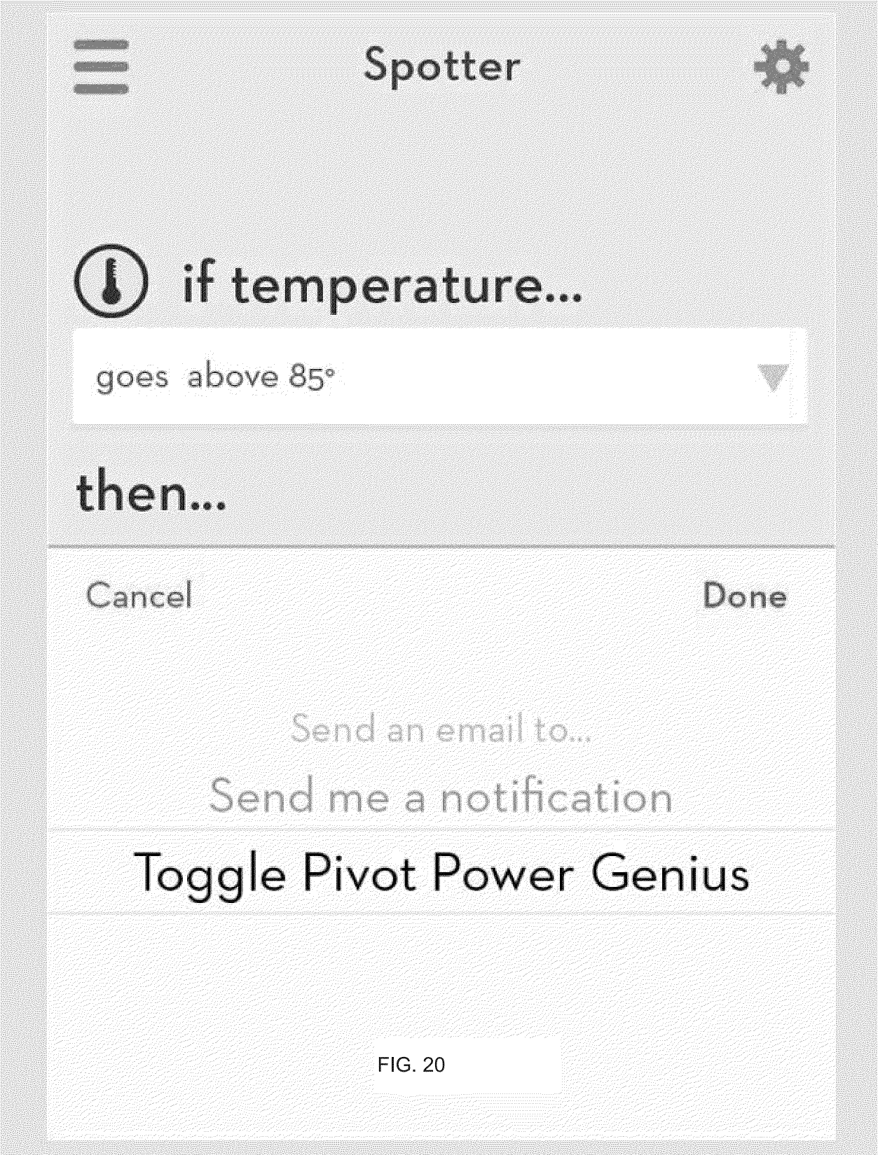

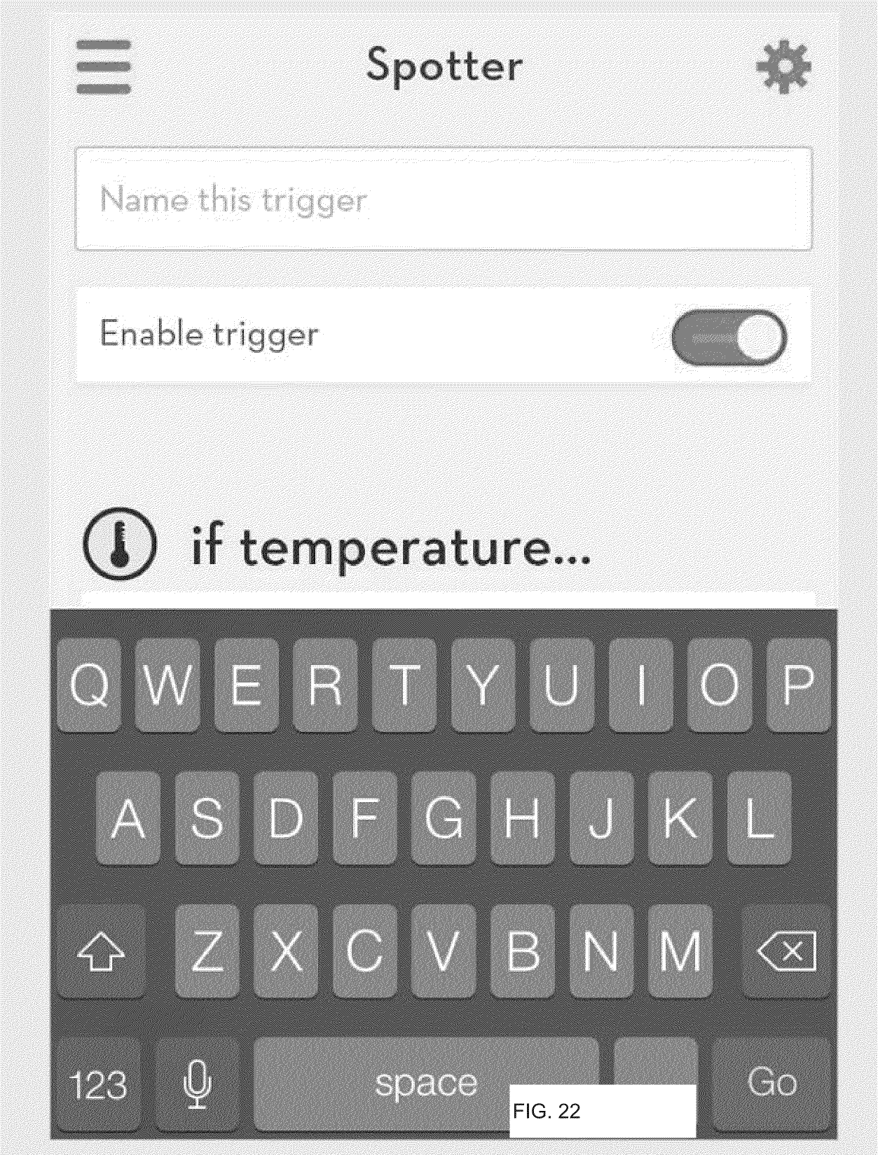

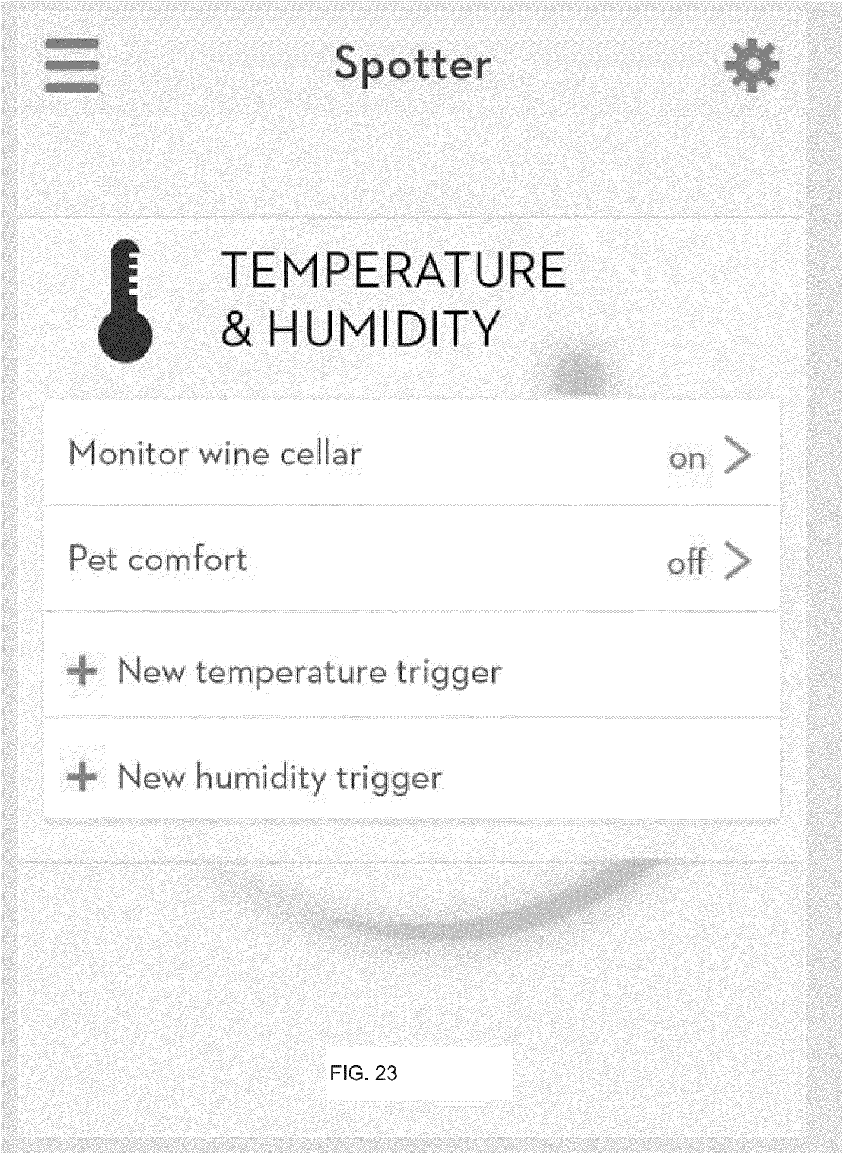

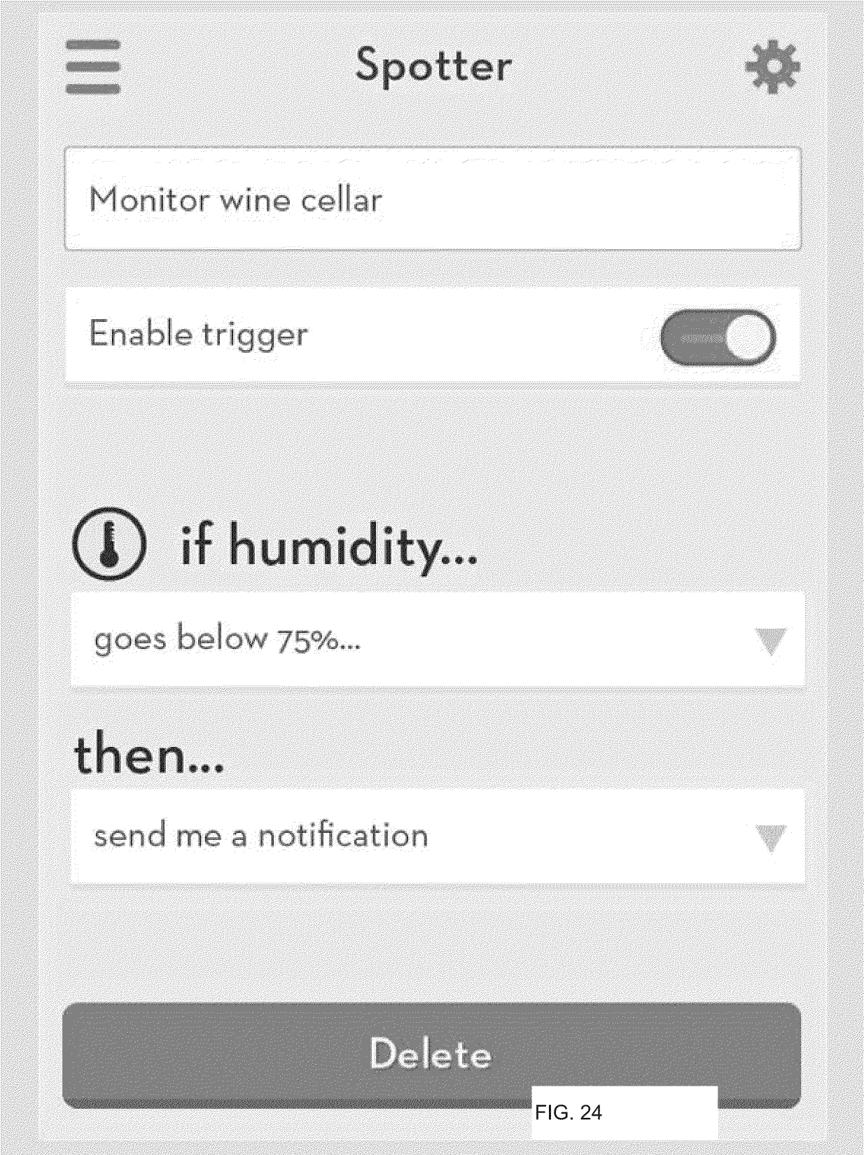

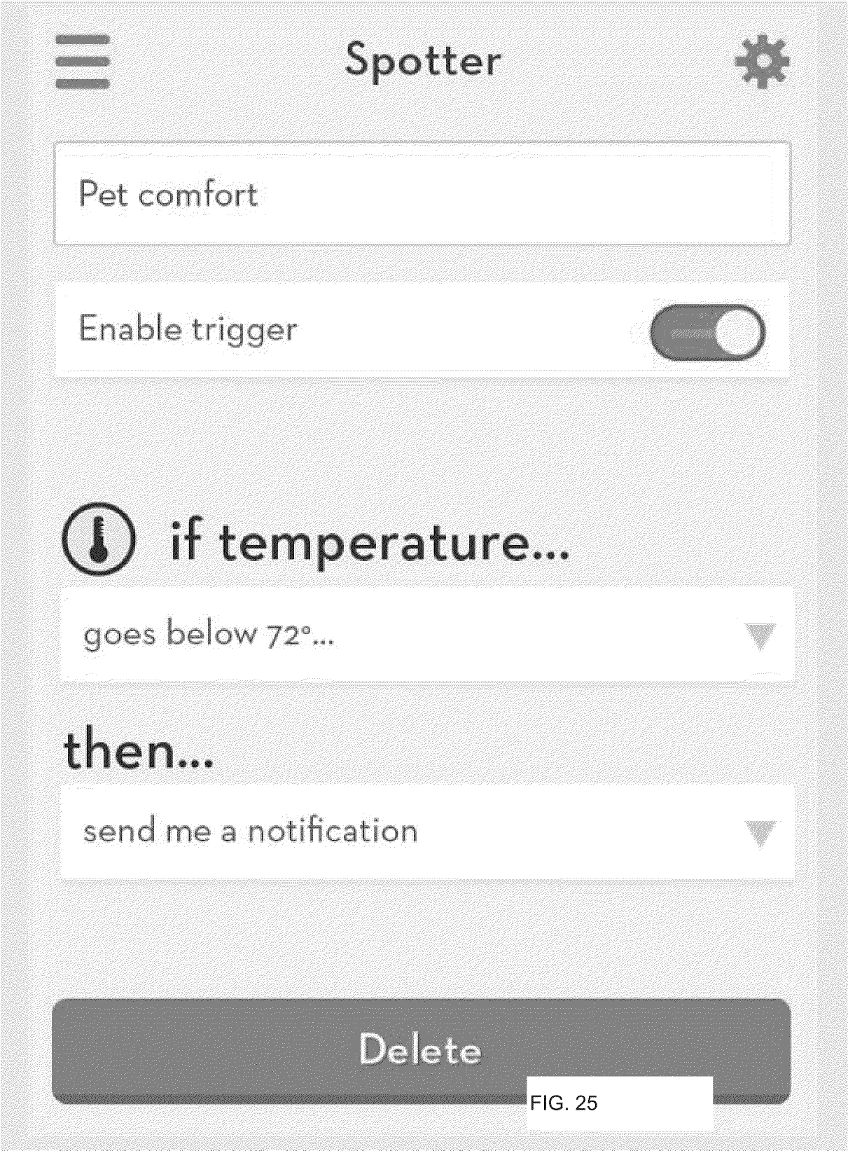

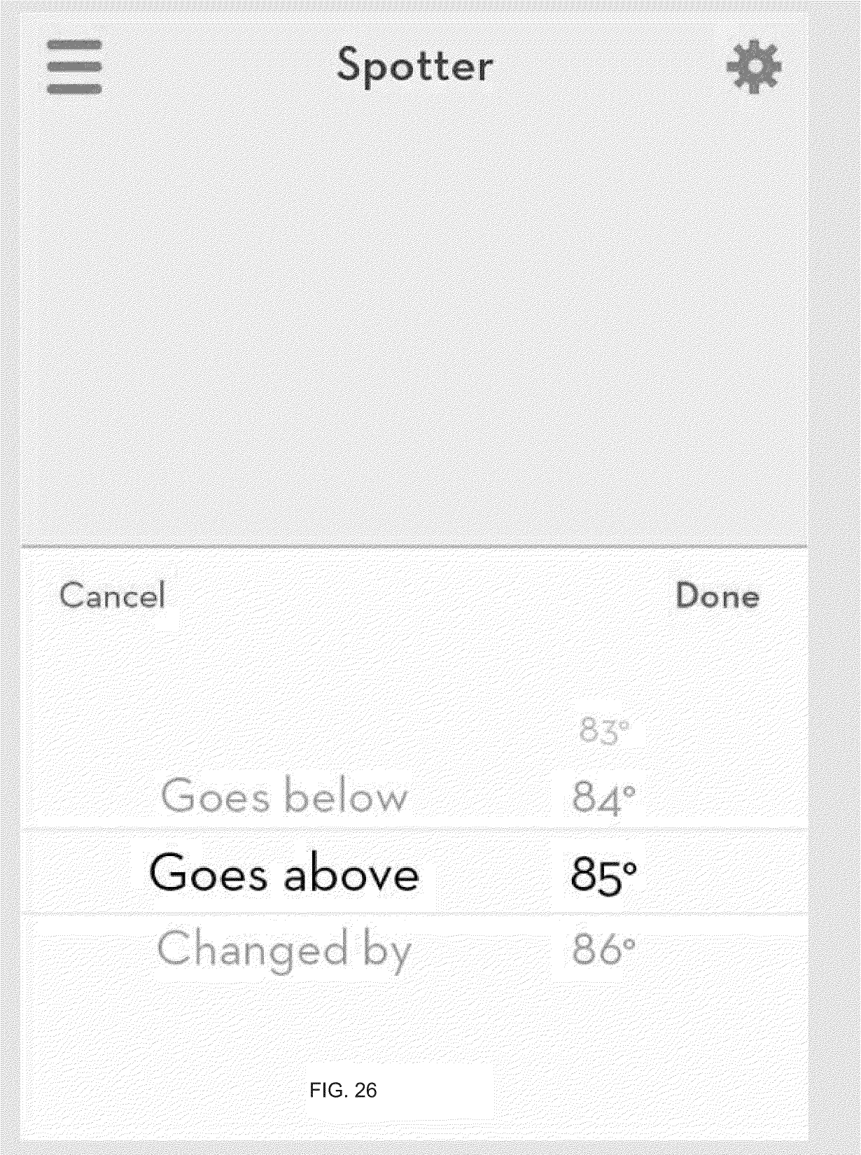

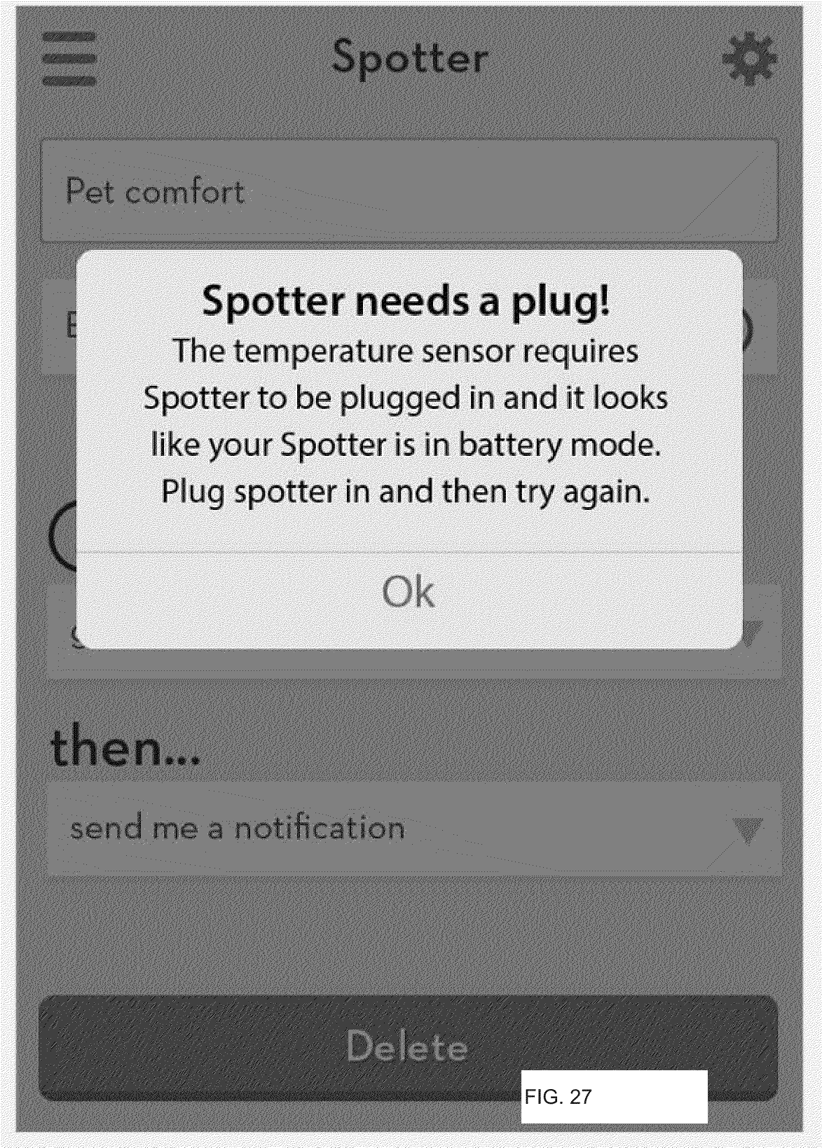

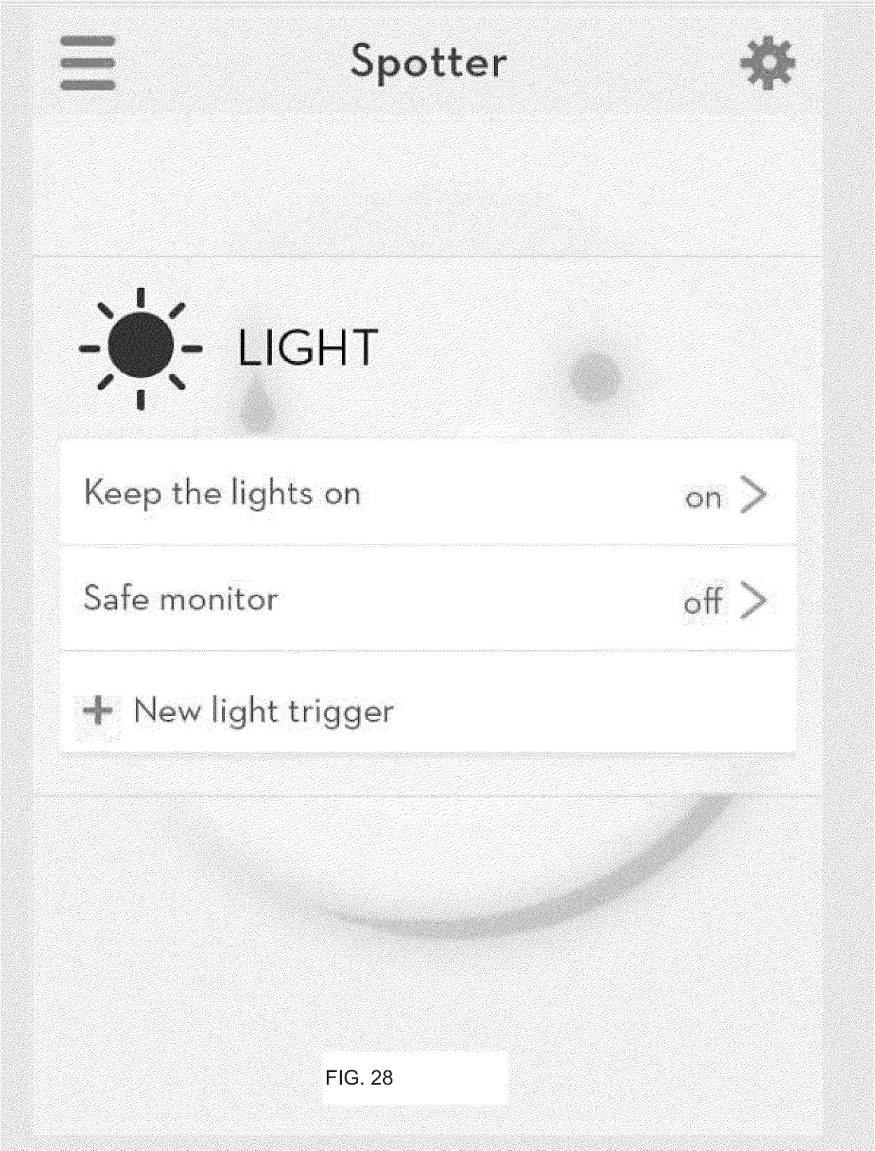

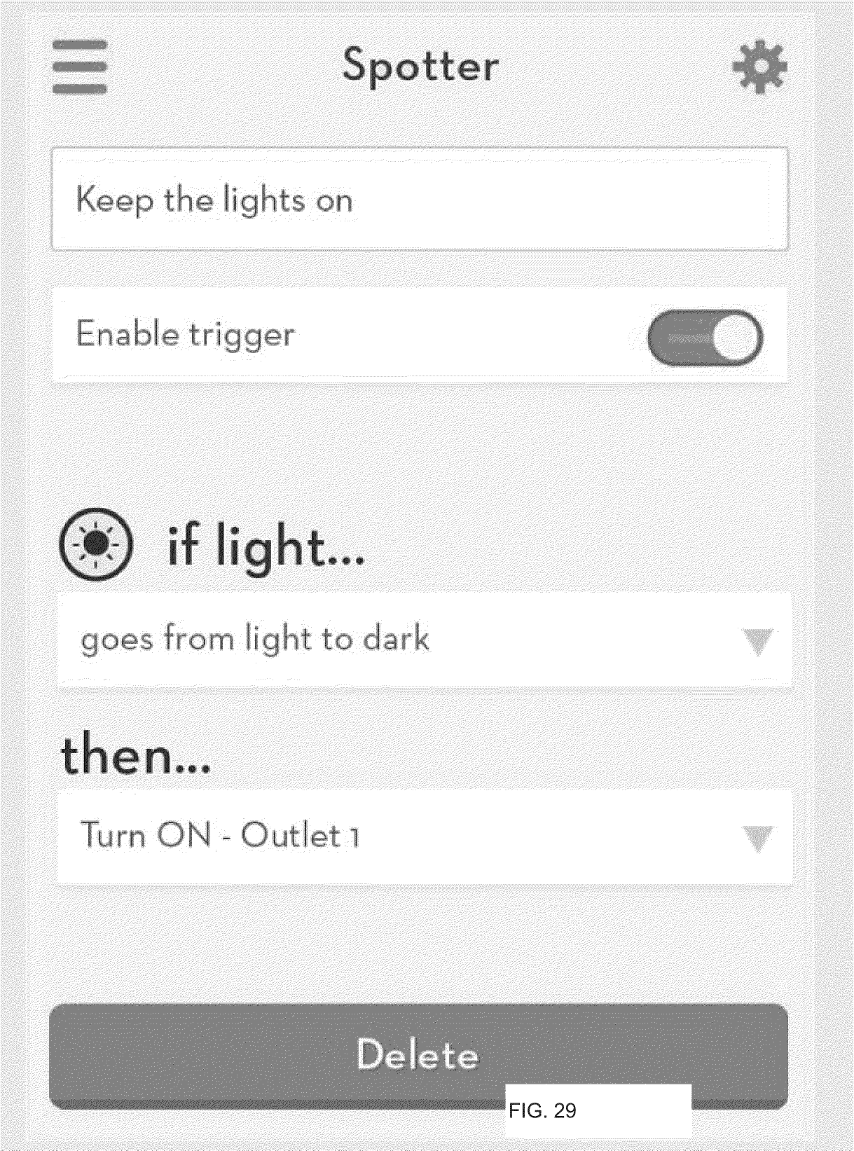

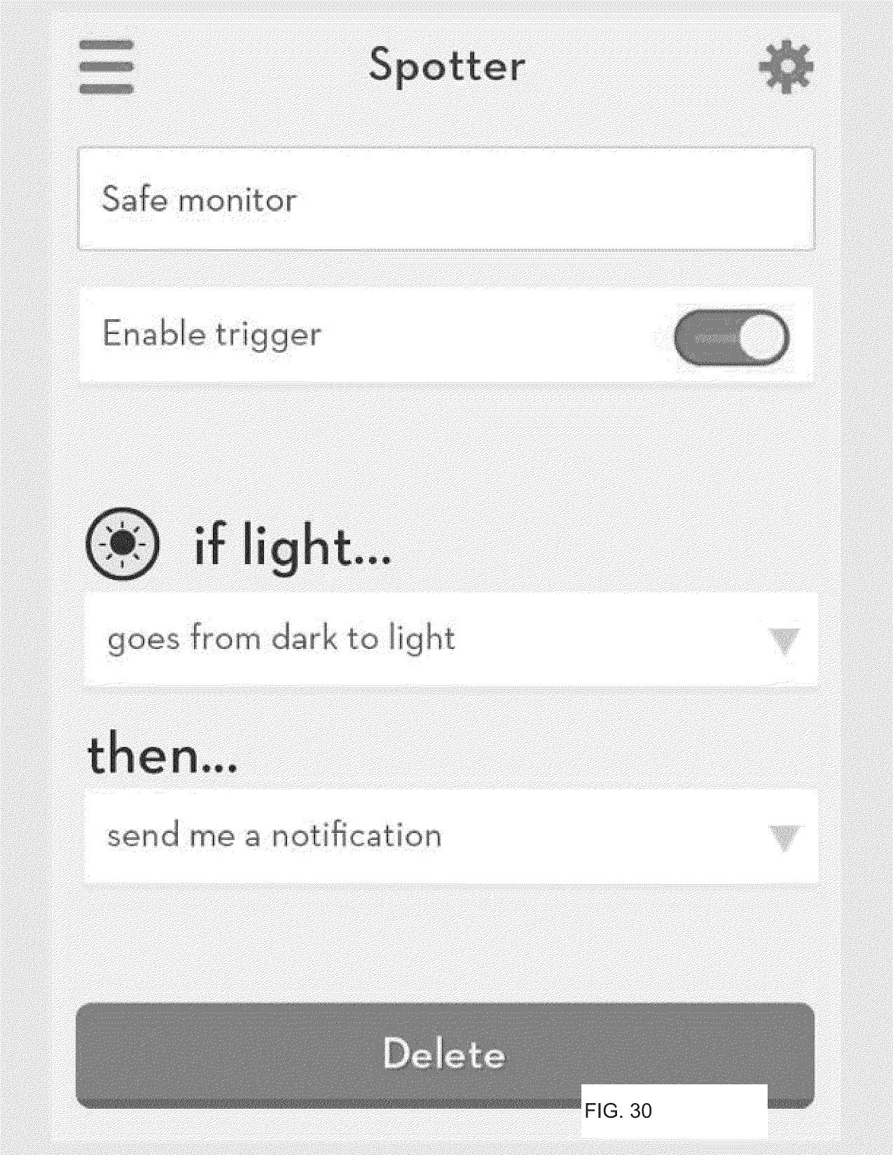

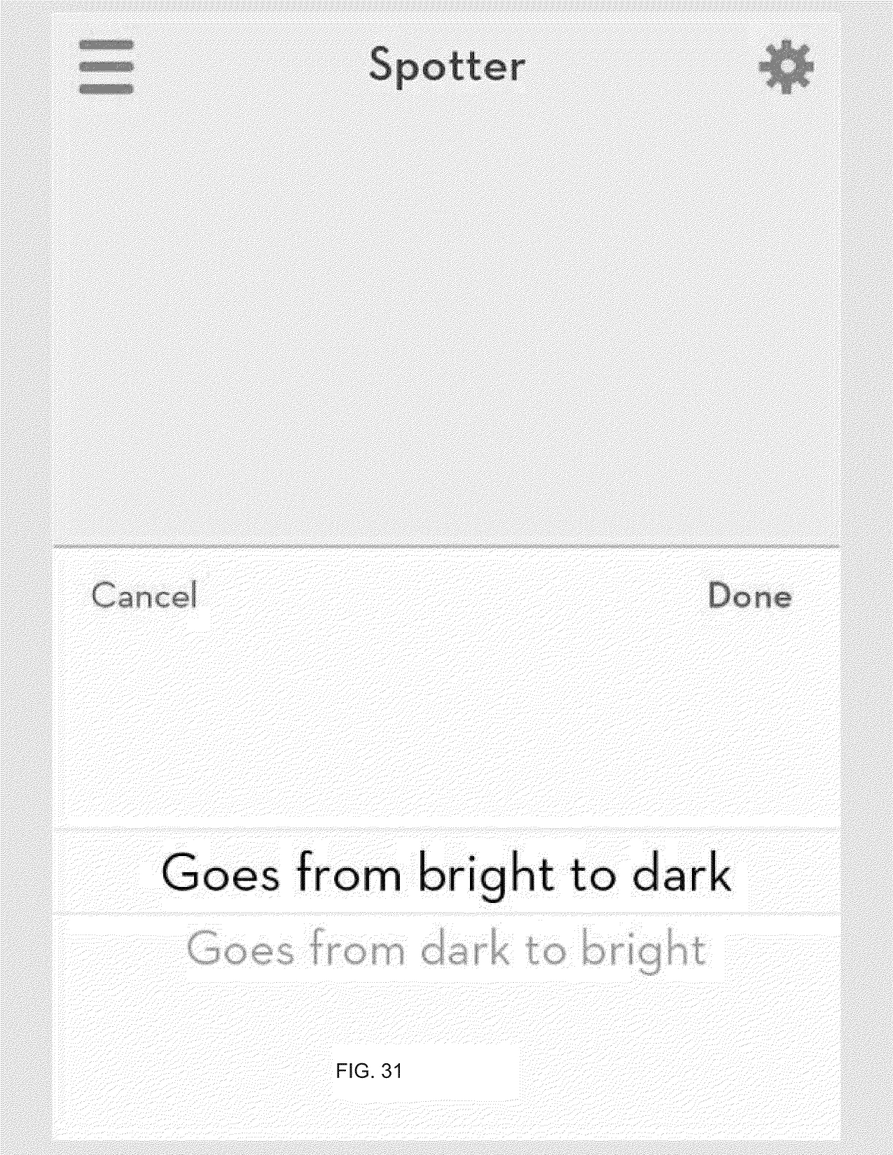

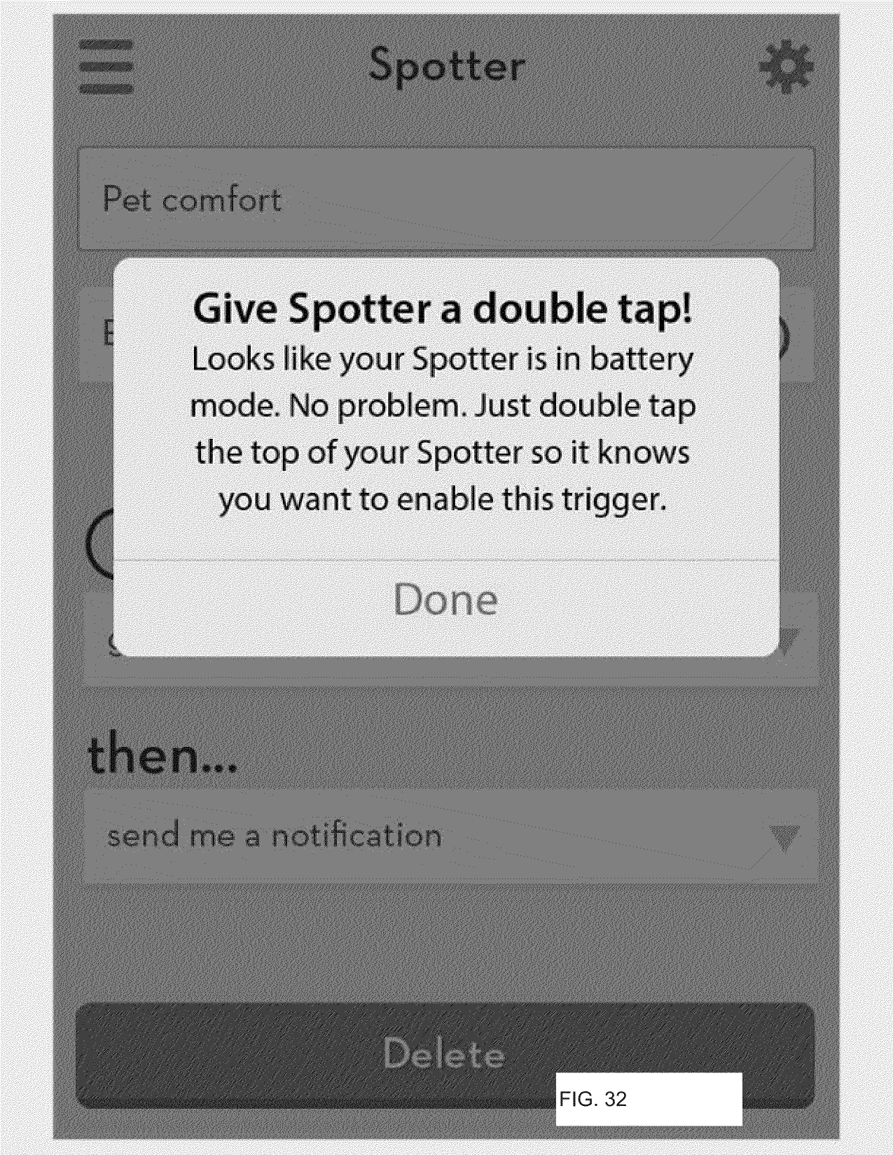

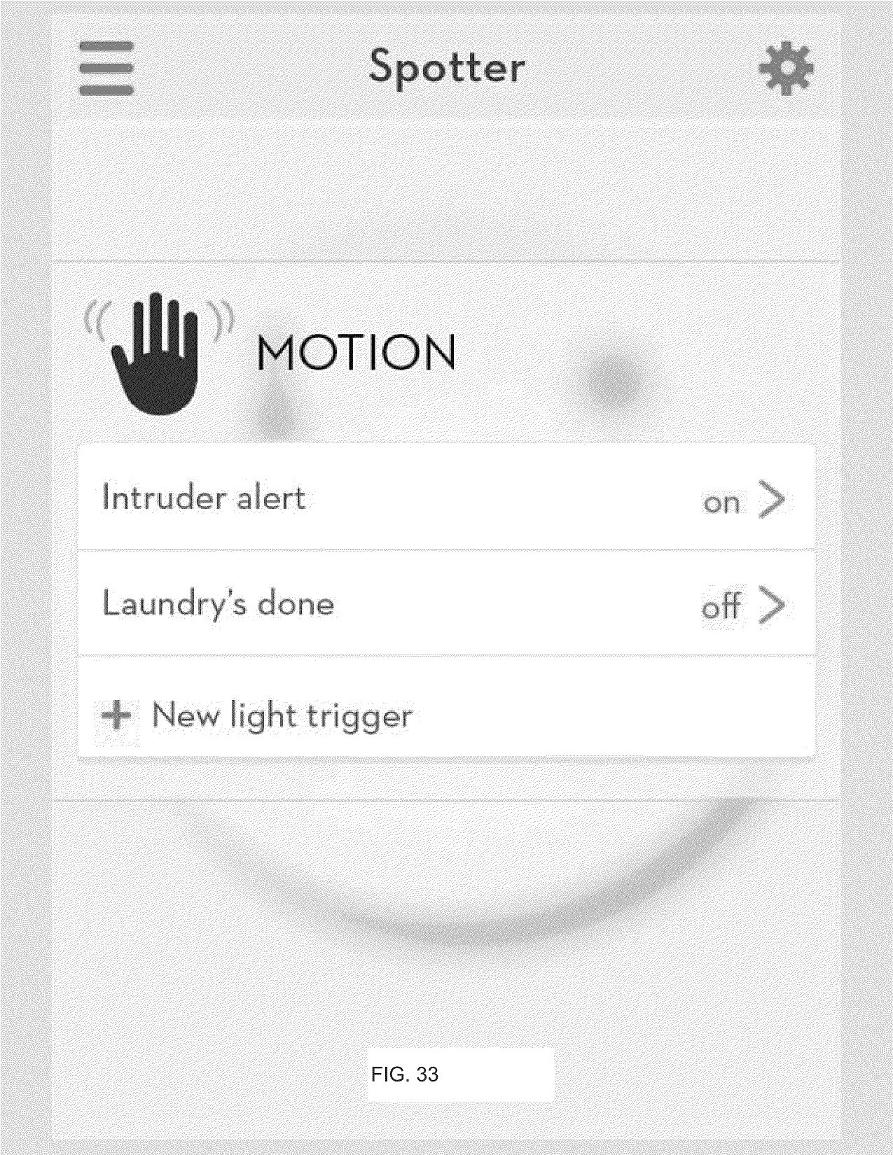

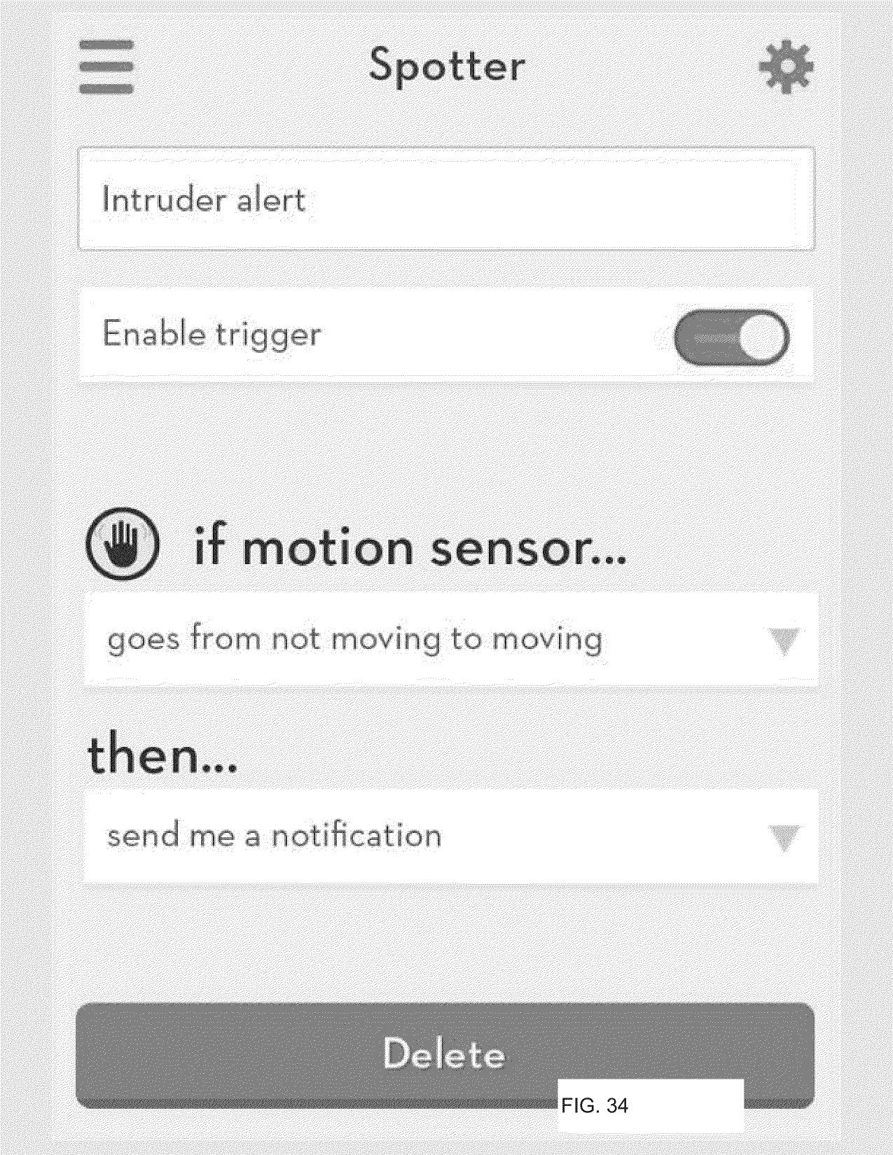

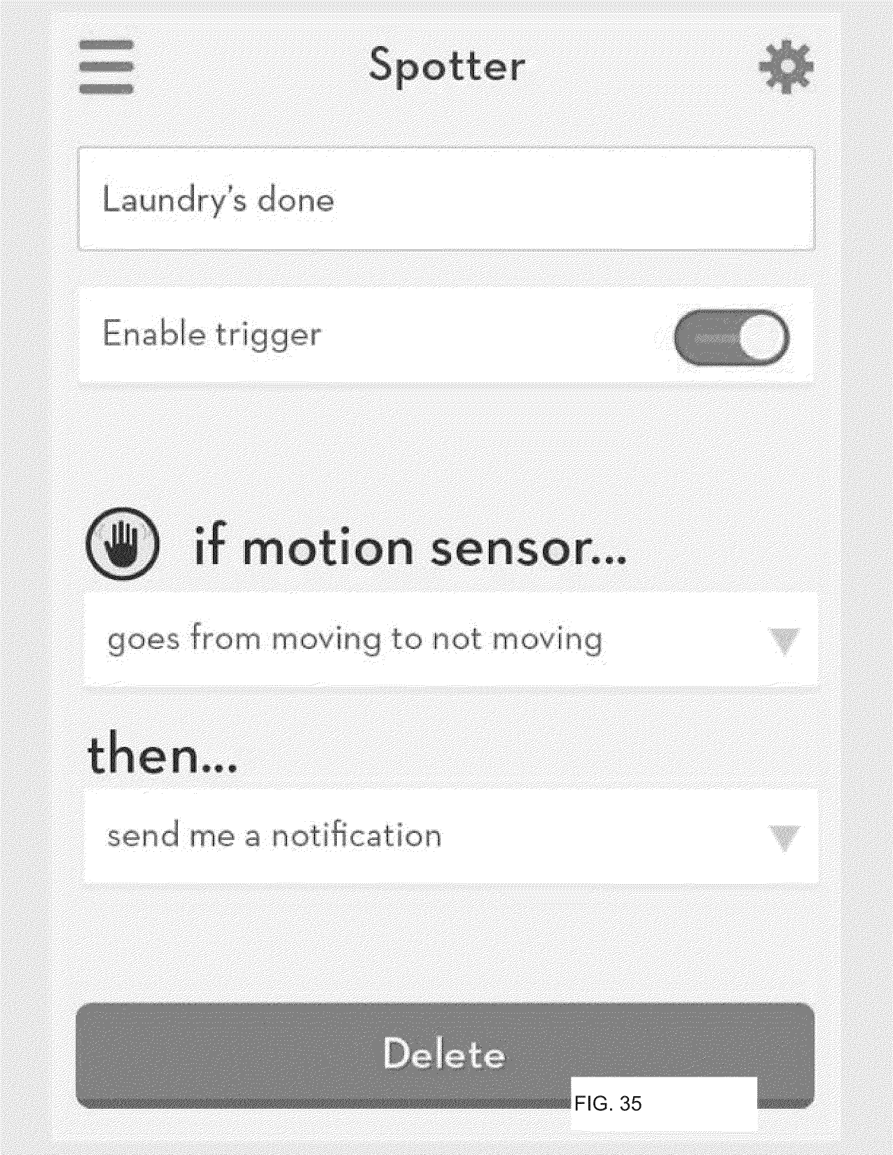

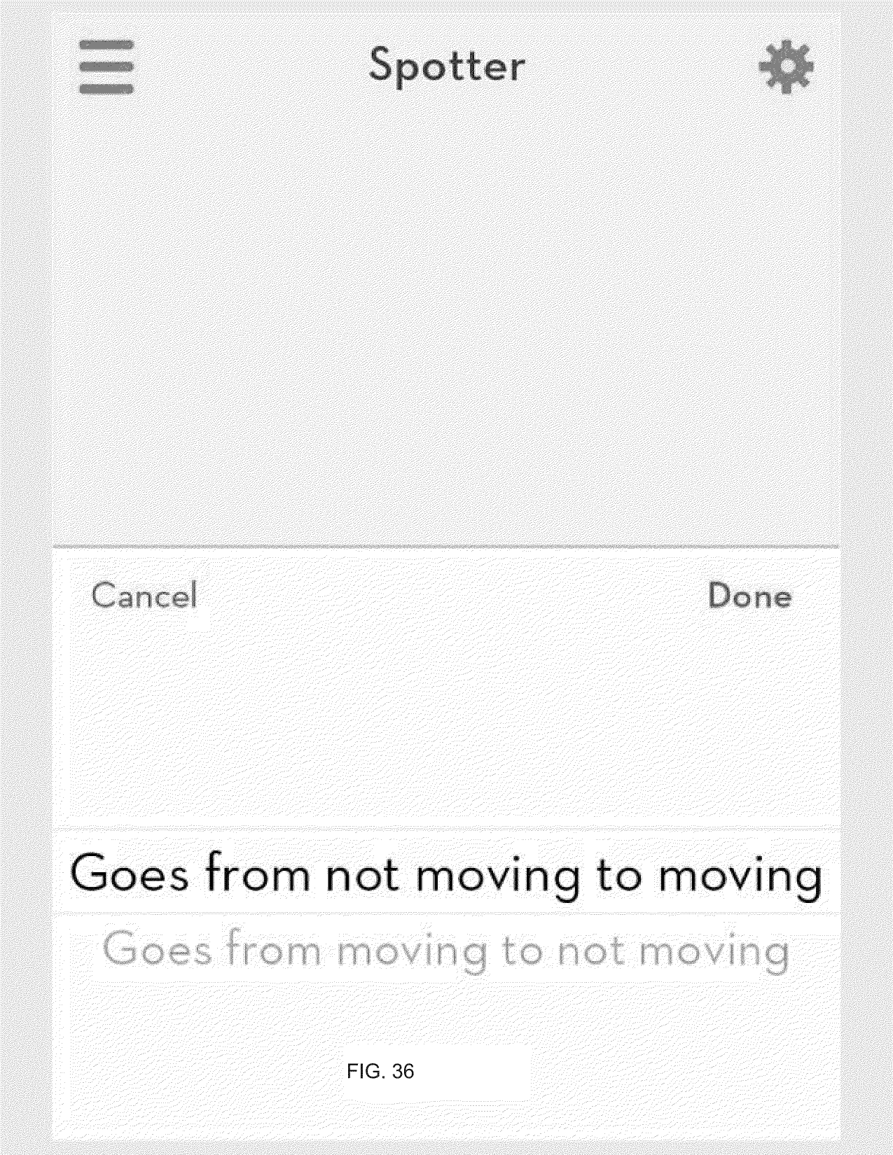

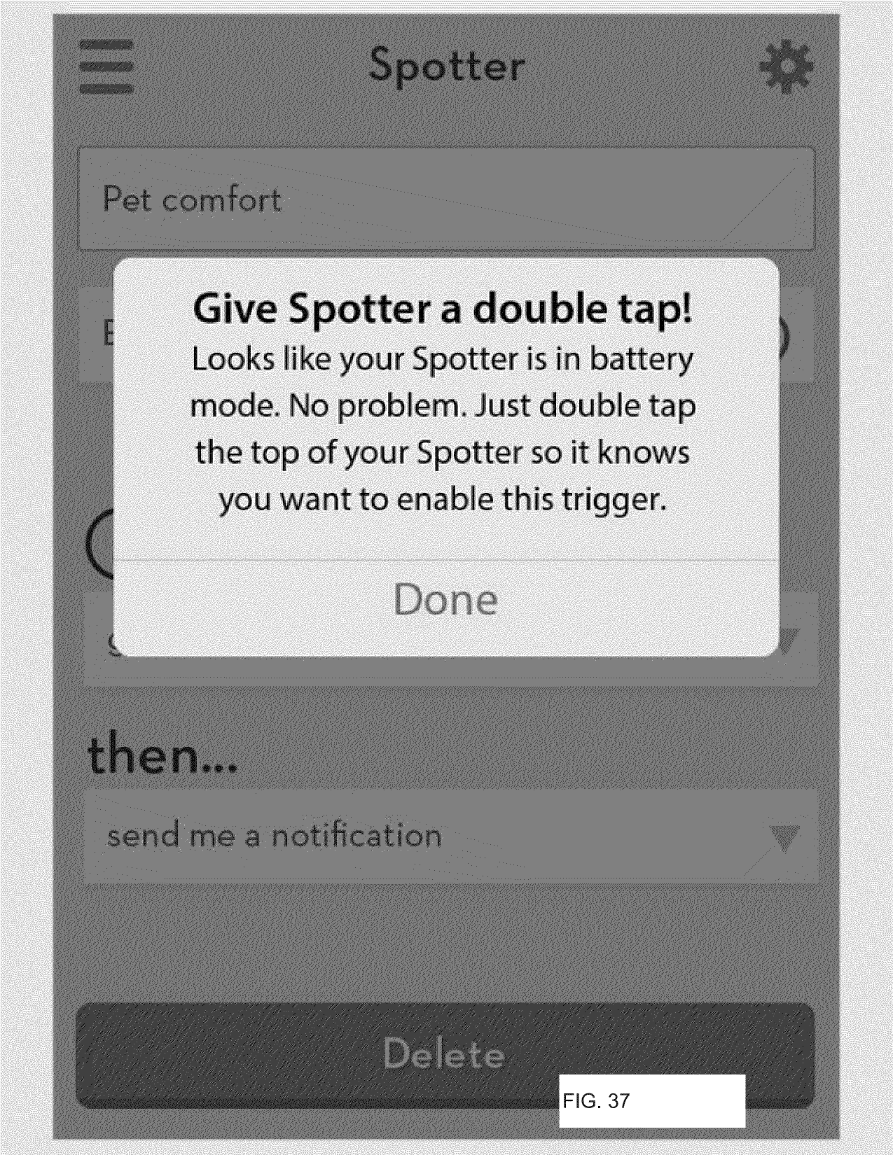

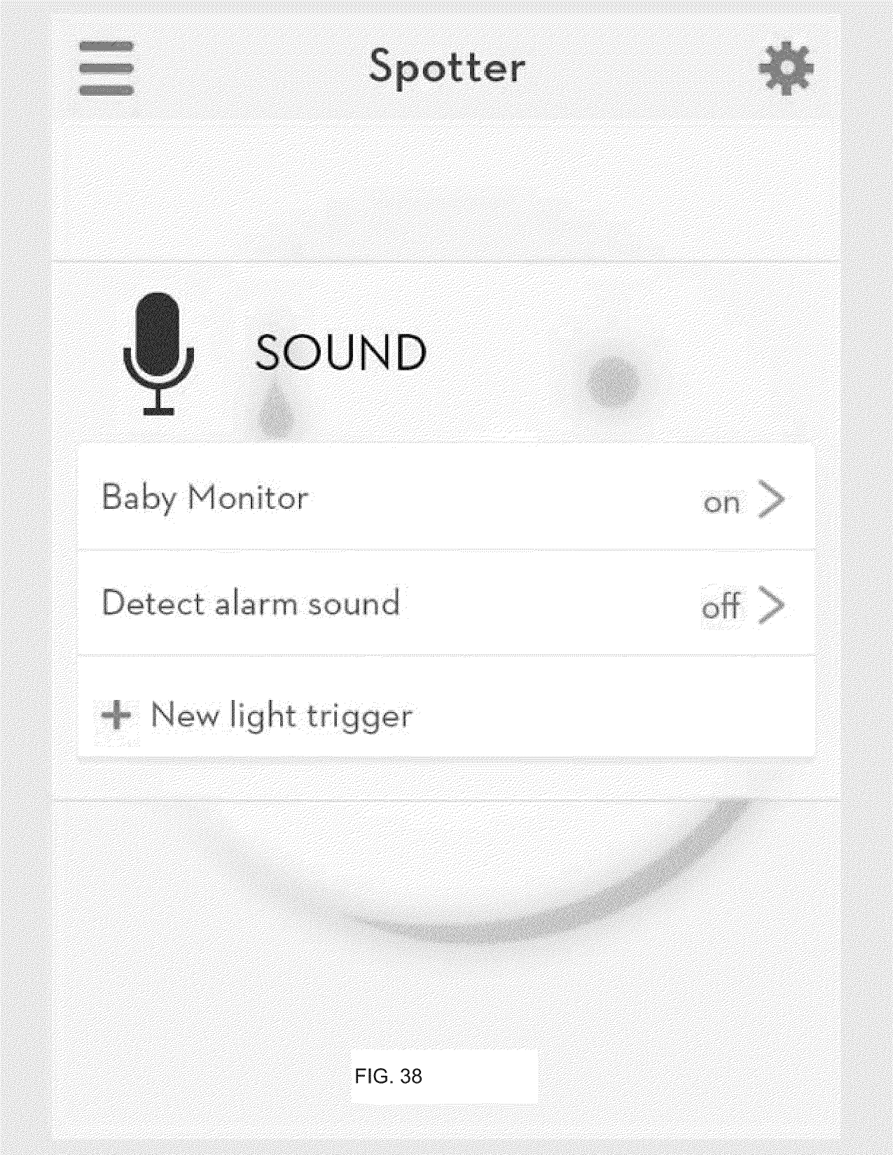

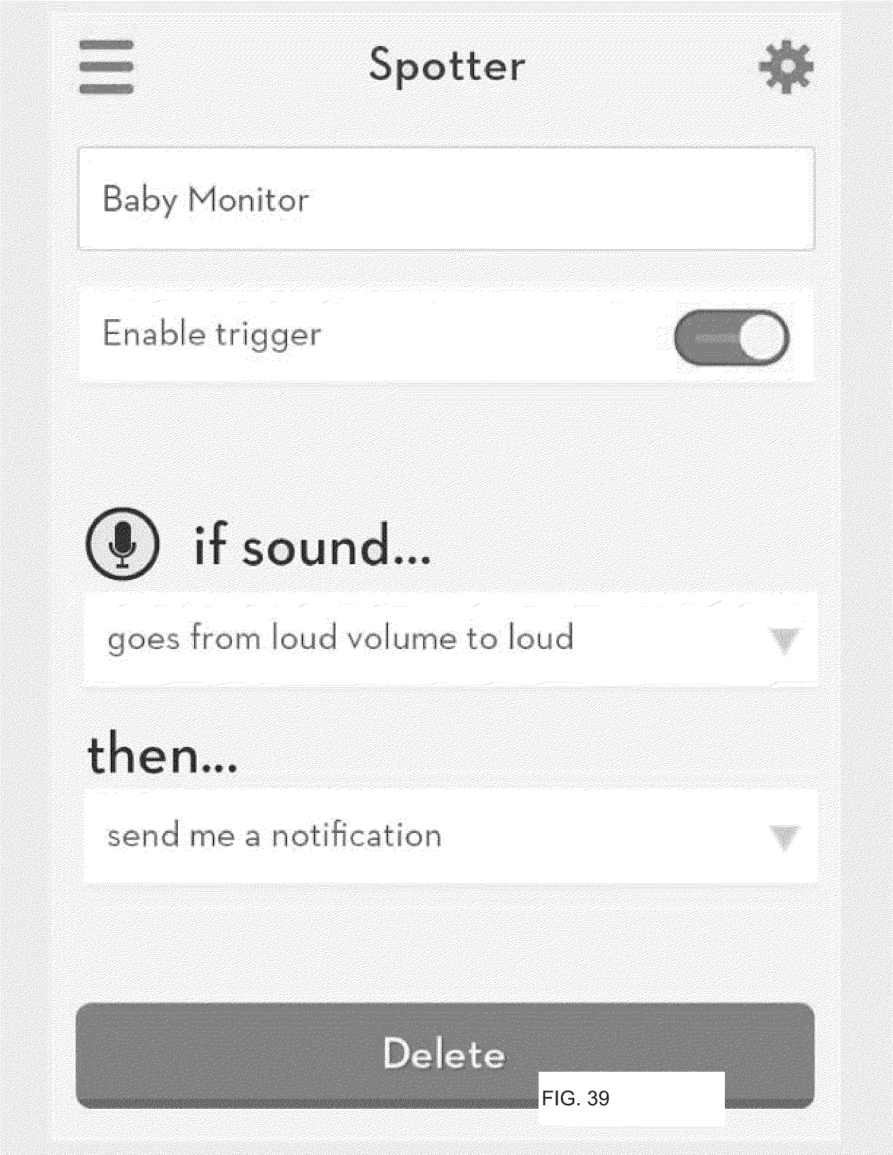

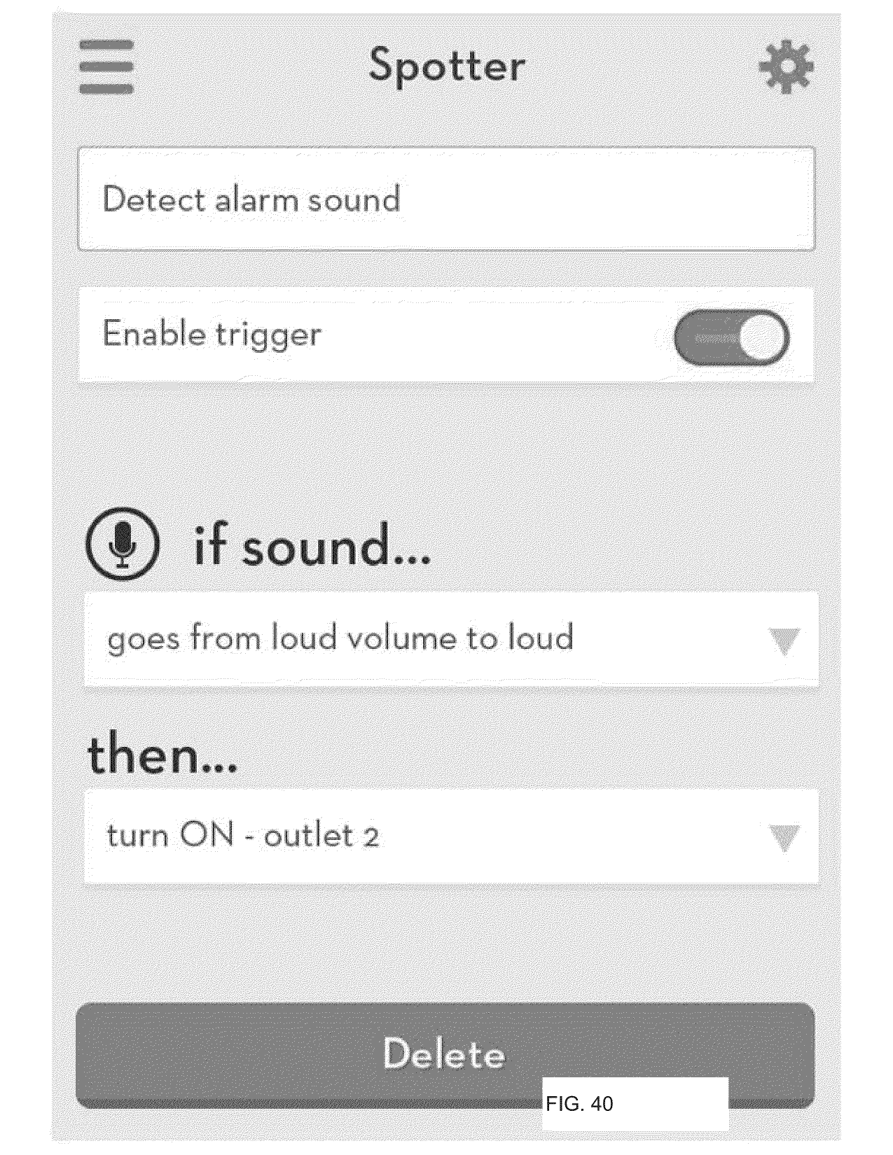

FIGS. 14-43 depict exemplary app screens.

An exemplary “open box” experience for a user may comprise the following: (a) removes Sensor apparatus from packaging; (b) pulls ribbon off batteries; (c) LED lights indicate Sensor apparatus is alive (e.g., all LEDs blink at once); (d) attaches Sensor apparatus in desired location.

In one or more exemplary embodiments, a user app experience may comprise: (1) user opens app; (2) opening app pulls most recent data showing status of each sensor; and/or (3) each time the status changes, the server is updated, but the user needs to refresh the app in order to pull the updated info.

Push notifications: when sensor status changes, a push notification is sent to the app, telling the user that the status has changed (e.g., is at or below a threshold).

Other exemplary embodiments are depicted in FIGS. 44-46.

In the embodiment depicted in FIG. 44, the sensor may be used to detect temperature, vibration, motion, and light. Alerts and emails may be sent via Wink (i.e., via the app) based upon a user's preferences. The sensor may connect to the Wink platform through, for example, Broadcom WiFi technology.

The sensor device, in this embodiment, may have passive infrared detection capability, enabling motion-detection on both a moving surface—such as a door—or by passively scanning over an area. This allows the sensor device to be moved and placed in more desirable locations around the home. The sensor device may be used within a Wink (or other network) ecosystem, and may be used as a trigger to other connected devices (e.g., through a Wink Robot). The sensor device may contain internal magnets to be self-adhering to metallic surfaces, such as refrigerator doors, and may be sold with additional hardware in the box to attach to any surface.

Exemplary Setup Procedure:

The user may be instructed to set up the sensor device using the most updated Wink app. Wink is available on both iOS and Android enabled devices, including phones, tablets, etc. Other embodiments may be used with other portable and non-portable computing devices, with appropriate applications running But for convenience, the present description refers to any computing device running an appropriate app as a “smart phone.”

1. User is prompted to download the Wink app on their iOS or Android device (“smart phone”).

2. User creates a Wink app account on their smart phone.

3. The Wink app provides an icon on the smart phone for the sensor device setup with on-screen instructions.

4. The setup portion of the app requests the user to power on the device.

5. Once the device is powered on, the user connects the app on the smart phone to the device using a wireless network.

6. The setup portion of the app instructs the user to enter preferences in the app for push notifications from the sensor device.

7. The app instructs the user to enable/disable certain sensors. User can also set sample and report rates for each sensor.

8. The app requests the user to install the sensor device in a desired location and to confirm WiFi connectivity.

Exemplary UI Features
Sensor device may have a bi-color LED to indicate status through a light pipe (e.g., in a logo);
Sensor device may have an audible alarm for positive trigger and low battery. (60 dB)
Sensor device may be wakeable via the accelerometer in order to check status on the LEDs;
Sensor device App may have a screen showing current status of a unit, including, for example:
   Connectivity, or time since last known good connection;
   Current sensor status: value and units;
   Current battery level;
   History of previous sensor readings values and units;
Sensor device Wink App may give provide the following functionality:
   Ability to turn on/off any sensor
   Ability to set unlimited alert events associated with any sensor
   Ability to offer users a preference for notifications
   Ability to associate a sensor with, e.g., a Wink Robot, tied to the actions of other connected devices.

Thresholds for alarm trigger sensitivity may stored locally on the device firmware (software). The device may be designed to normally not be in communication with the WiFi network, as a means to save battery (sleepy mode). If a sensor is triggered, the device may first reference the threshold locally to determine whether the measurement is substantial enough to send up to the cloud (server). If it is, the firmware may wake up from sleepy mode, connect to the WiFi network, and send the relevant data.

For robustness, the threshold data may be stored both on the device and in the cloud. As a further option, the threshold data may be stored by the app.

In addition, the device firmware may have a regular schedule of waking up and sending a “ping” throughout the day to confirm that it is functioning correctly and has WiFi connectivity.

Exemplary Usage
A user may use the sensor device to detect multiple environmental changes, and request device notifications on those changes.
The sensor device may be used in concert with other smart devices to act as a trigger mechanism for home or other automation functionality.
The user may be alerted via the app and/or the LED on the device of battery status.
The user may mount the sensor device using various means, such as double-sided tape pads or wood screws.
The batteries (e.g., 2 AA batteries) may last 12 months at a minimum without need for changing.

Exemplary Sensor Features
Accelerometer (Vibration)
Photo diode (Ambient Light)
Thermometer Sensor (Temperature)
Passive Infrared Sensor (e.g., Narrow Beam Motion, Wide Beam Motion)

Exemplary Technical Details
Weight: <2 lbs
Approximate dimensions: <4 in. diameter, <1 in. height
RF Technology: Broadcom WiFi
OTA (over the air) Updateable: Yes
iOS Support: iPhone 3GS, 4, 4s, 5, 5s/iPad 2nd, 3rd, 4th gen, mini/iPod touch 4th, 5th gen
Android Support: Android 2.2 and above, all devices
May include a factory re-set button (e.g., embedded inside of the battery holder plastic body) that allows the Sensor to return to factory settings (e.g., to enable the Sensor to connect to a different WiFi network and/or discard all triggers)

Exemplary Test Requirements
Functional temperature range of −20C to 50C
Functional at 100% relative humidity for set time period
Drop test 1.5 m to concrete, 5×, functional
ESD safe to 4 kV, main body and through aux ports (if any)
Minimum of 12 months battery life with all sensors enabled, without logging functionality

In an exemplary embodiment, a sensor apparatus may be constructed modularly. An application or website may allow a user to make a color selection for an exterior surface, and/or to select a custom configuration of sensors and accessory features.

The application/website may comprise an online configurator (typically a web interface) that allows the customer to select sensor options, and use cases for each. Customers may also be able to visualize how the end product will look with various color/feature modifications selected by the user.

In an exemplary embodiment, modularity in the board design enables user selection of modules. The sensor apparatus may be segmented into four quadrants, and a user allowed to select a sensor/button/blank panel for each quadrant. The sensor apparatuses may use one or more boards in common, and each quadrant can have multiple inputs. Preferably, only one of those inputs will be populated, per quadrant per product. This allows users to select from many different custom Spotters with unique functionality.

Sensors may be grouped and designed to be mutually exclusive. For example, the temperature and temperature/humidity sensor may in the same quadrant. If the user selects one, the user is unable to select the other. Sensors may be grouped according to similar use-cases.

An exemplary embodiment comprises a circuit board that includes footprints for any available sensor, and supporting circuitry. FIG. 47 depicts an exemplary modular circuit board, in a four-sensor configuration. FIG. 48 depicts an exemplary modular circuit board, without an accelerometer.

All required components that are the same for all Spotters (power supply, WiFi SoC, antenna, LEDs, etc.) may be pre-installed prior to customization. See FIG. 55. Although not depicted as being separated in FIG. 55, the round center of the top of the spotter (“top body”) also may be a pop-in panel.

When a customer chooses a specific combination of sensors, a seller may populate the chosen sensors and supporting circuitry on an individual Spotter, attach the appropriate plastic pieces, then provide the customized product to the customer.

In another exemplary embodiment, a customer may be provided with one or more modules, so that the customer can configure/modify their own sensor apparatus after purchase.

Exemplary features of a configuration application are described below (see also FIG. 51):

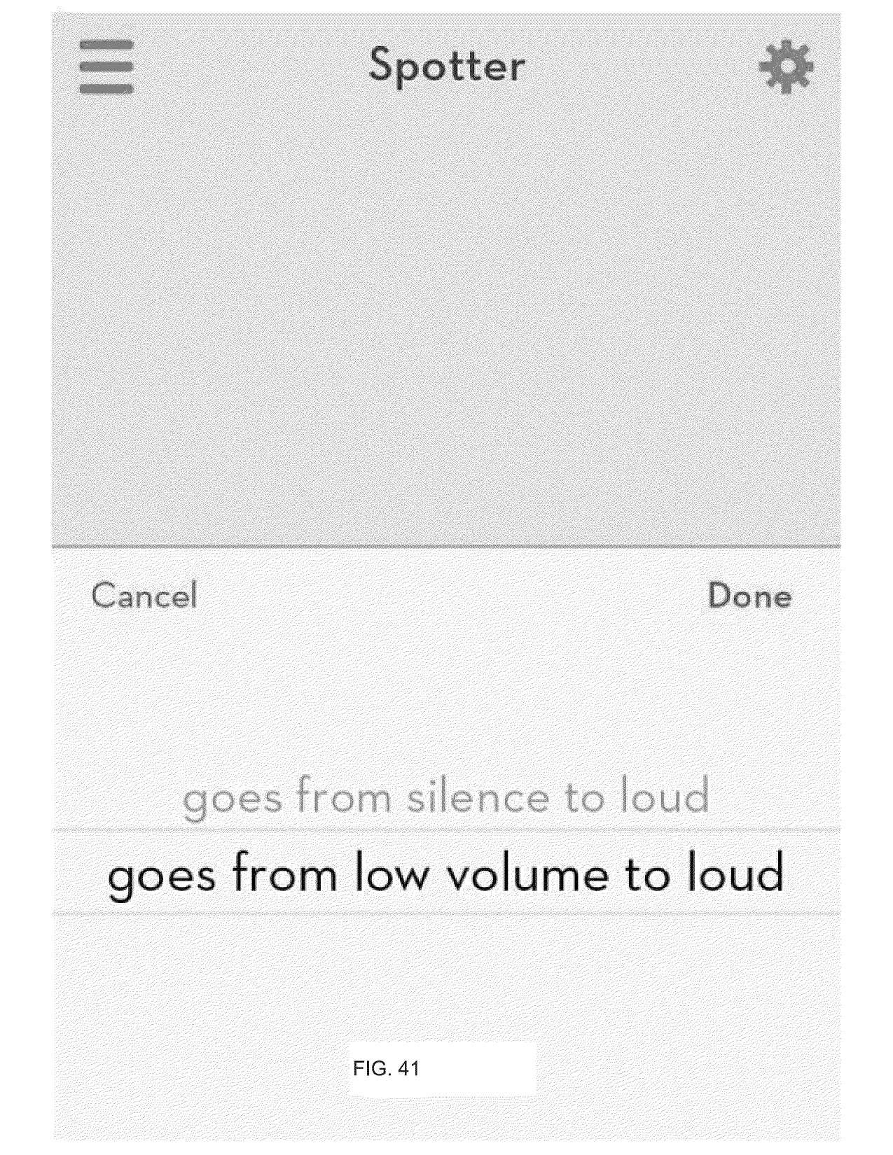

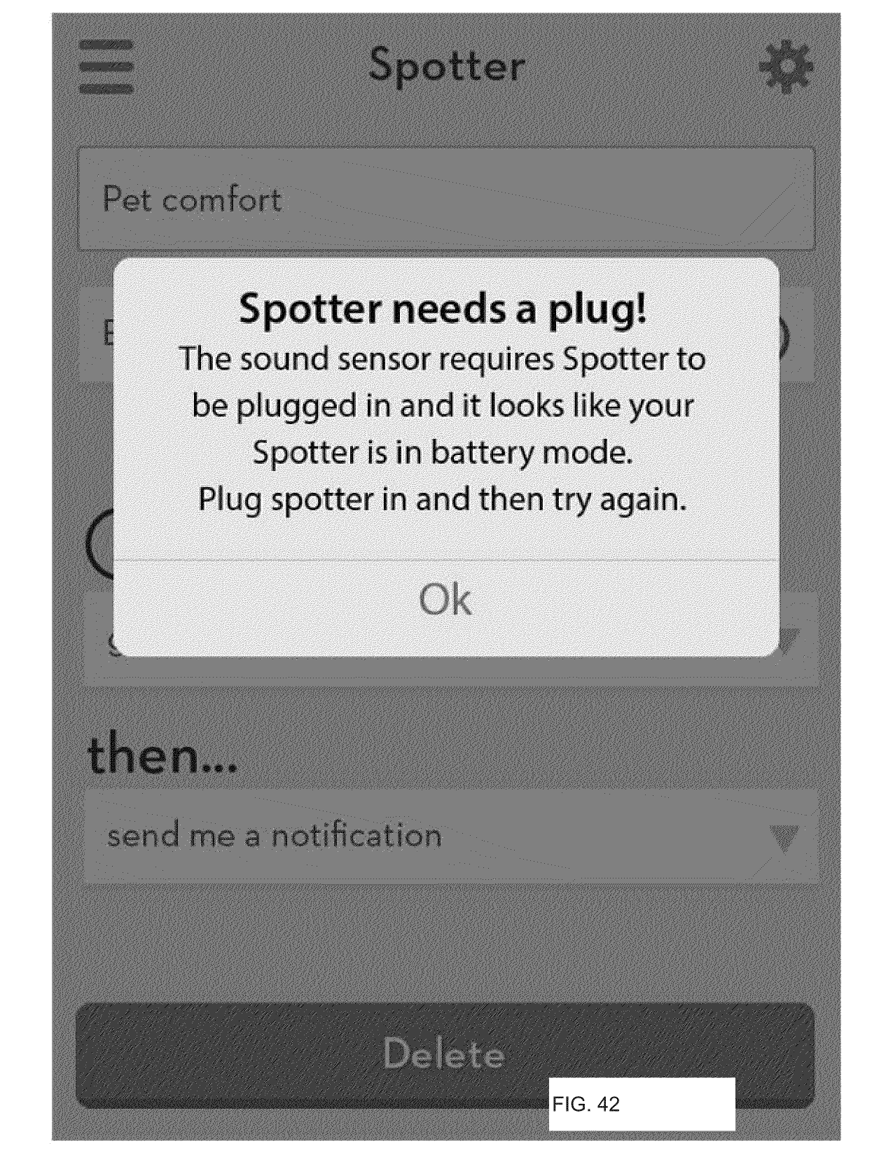

A user may choose from several (e.g. six) sensor options (see FIG. 52):
User may be presented with a bare Spotter with blank panels
As a sensor is selected, the appropriate panel on the Spotter is auto-updated
As a sensor is selected, the paired sensor, if any, is removed as an option
A User may choose between a plurality of sensors
Unpopulated quadrants are assumed to be blank panels

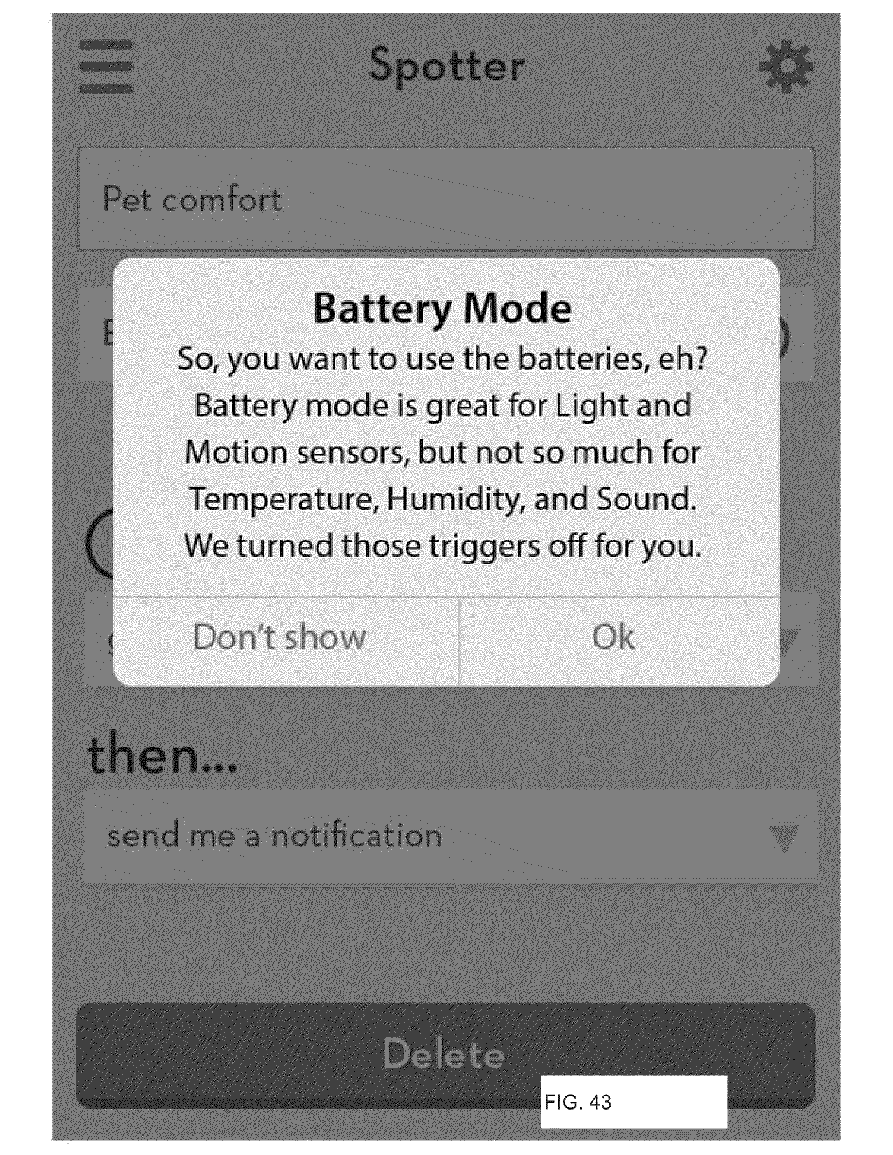

A User may choose from a plurality of color options (see FIG. 54):
A User may apply a color option to one of several surfaces
As a surface is selected, a menu of colors may be presented
Once a color is selected, the Spotter image may auto-update

A User may select from additional options
If a user selects a plugin option, a micro-USB port may appear on the Spotter image
If a user selects a lithium-ion option, the Spotter image may appear with a thinner profile

As options are added, a custom Spotter price may auto-update
Each option may be assigned a unique associated incremental price
The Spotter price may increase incrementally as sensors/features are added

Once a user has customized a Spotter, the user may be placed into a normal buying workflow

Color options may be applied to the following surfaces:
Four quadrant panels (top surface)
One center “house” panel (top surface)
One housing top (top half)
One housing bottom, interior (bottom half, hidden)
One housing bottom, exterior (bottom half, visible)

Sensor Options
Temperature
Temperature+Humidity
Sound
Light
Accelerometer
Passive Infrared
Button (between 2-4)
Blank Panel
Moisture/Leak
Carbon Monoxide
Air Quality/Smoke
LED Screen
Magnetic/Contact
Gyroscope
Barometric Pressure

Note on Pairing: in an embodiment, there are four designated quadrants, and the customer may only choose up to four sensors. Sensor inputs are “paired” on the internal electronics board, and are therefore mutually exclusive (i.e., if a user selected Option A, paired Option B will become greyed out). Below is an exemplary list of paired sensors:

Quadrant 1: Temperature/Temperature+Humidity

Quadrant 2: Accelerometer

Quadrant 3: Light/Sound

Quadrant 4: Passive Infrared

Other sensors also may, of course, be made available, and paired, and the pairings listed above may differ. In addition, blank panels of any color may be applied to any quadrant if the user wants to select less than 4 sensors.

Additional Feature Options:
Lithium ion rechargeable battery (default will ship with 2× AA)
Plugin power option
Custom message pad-printing
Custom logo printing

An exemplary embodiment includes circuitry/firmware/software that allows a user to turn off selected sensors to conserve battery power.

For example,

1. On the smart phone app, a user may select an option to turn on/off sensors such as temperature, humidity, sound etc.

2. This sends a message to, e.g., connected hardware (WiFi System-On-Chip (SoC)) to enable/disable the power tied to the selected sensor with a GPIO (General Purpose Input/Output) pin going low/high.

3. The low/high signal from the GPIO may enable/disable a MOSFET latching circuit that allows electric current to flow/stop, thus enabling or disabling the sensor and supporting circuitry.

While certain exemplary aspects and embodiments have been described herein, many alternatives, modifications, and variations will be apparent to those skilled in the art. Accordingly, exemplary aspects and embodiments set forth herein are intended to be illustrative, not limiting. Various modifications may be made without departing from the spirit and scope of the disclosure.

We claim:

1. An apparatus comprising:
a microprocessor;
a wireless transmitter/receiver in communication with said microprocessor and operable to communicate over a wireless network with an application on a mobile device;
a light sensor in communication, via said microprocessor and said transmitter/receiver, with said application, and operable to detect and report ambient light levels in a vicinity of said apparatus; and
an accelerometer in communication, via said microprocessor and said transmitter/receiver, with said application, and operable to detect and report motion of said apparatus.

2. An apparatus as in claim 1, further comprising a temperature sensor in communication, via said microprocessor and said transmitter/receiver, with said application, and operable to measure and report temperature in a vicinity of said apparatus.

3. An apparatus as in claim 1, further comprising a humidity sensor in communication, via said microprocessor and said transmitter/receiver, with said application, and operable to measure and report relative humidity in a vicinity of said apparatus.

4. An apparatus as in claim 1, further comprising a microphone in communication, via said microprocessor and said transmitter/receiver, with said application, and operable to detect and report sound in a vicinity of said apparatus.

5. An apparatus as in claim 1, further comprising a passive infrared sensor in communication, via said microprocessor and said transmitter/receiver, with said application, and operable to detect and report motion in a vicinity of said apparatus.

6. An apparatus as in claim 1, wherein said apparatus is battery powered.

7. An apparatus as in claim 1, wherein said apparatus is further operable to communicate wirelessly with other home network devices via said wireless network.

8. An apparatus as in claim 1, wherein said microprocessor is mounted on a circuit board that enables interchangeability of at least said light sensor and another sensor.

9. A method of modifying the apparatus of claim 8, comprising:
removing a first sensor from said apparatus; and
replacing said first sensor with a second sensor.

10. A method of modifying the apparatus of claim 8, comprising removing a sensor from said apparatus.

11. A method of modifying the apparatus of claim 8, comprising adding a sensor to said apparatus.

12. An apparatus as in claim 1, wherein said application enables a user to selectively activate and deactivate at least said one sensor on said apparatus.

13. A non-transitory computer readable medium storing software that enables a user to select one or more sensors to be included in the apparatus of claim 8.
